(19) United States
(12) Patent Application Publication
(10) Pub. No.: US 2018/0142154 A1
(43) Pub. Date: May 24, 2018

(54) LIQUID CRYSTAL COMPOSITION HAVING GOOD PHOTOSTABILITY AND THERMOSTABILITY, AND LIQUID CRYSTAL DISPLAY ELEMENT

(71) Applicant: JIANGSU HECHENG DISPLAY TECHNOLOGY CO., LTD., Jiangsu (CN)

(72) Inventors: Wenming HAN, Jiangsu (CN); Haibin XU, Jiangsu (CN); Wenquan DING, Jiangsu (CN); Wenyang MA, Jiangsu (CN); Zhaoyuan CHEN, Jiangsu (CN)

(73) Assignee: JIANGSU HECHENG DISPLAY TECHNOLOGY CO., LTD., Jiangsu (CN)

(21) Appl. No.: 15/567,972

(22) PCT Filed: Apr. 21, 2016
(86) PCT No.: PCT/CN2016/079944

§ 371 Date: Oct. 20, 2017

(30) Foreign Application Priority Data
Apr. 23, 2015 (CN) 201510197123.3

(51) Int. Cl. C09K 19/44; C09K 19/46; G02F 1/1333

(52) U.S. Cl. CPC C09K 19/44; G02F 1/1333; C09K 19/46

(57) ABSTRACT

A liquid crystal composition having good photostability and thermostability. The liquid crystal composition comprises: 5-30% of one or more compounds of general formula I based on the total weight of the liquid crystal composition; 1-30% of one or more compounds of general formula II based on the total weight of the liquid crystal composition; 1-30% of one or more compounds of general formula III based on the total weight of the liquid crystal composition; 1-20% of one or more compounds of general formula IV-1 and/or general formula IV-2 based on the total weight of the liquid crystal composition; and 15-50% of one or more compounds of general formula V based on the total weight of the liquid crystal composition. A liquid crystal display element containing the liquid crystal composition is also provided.

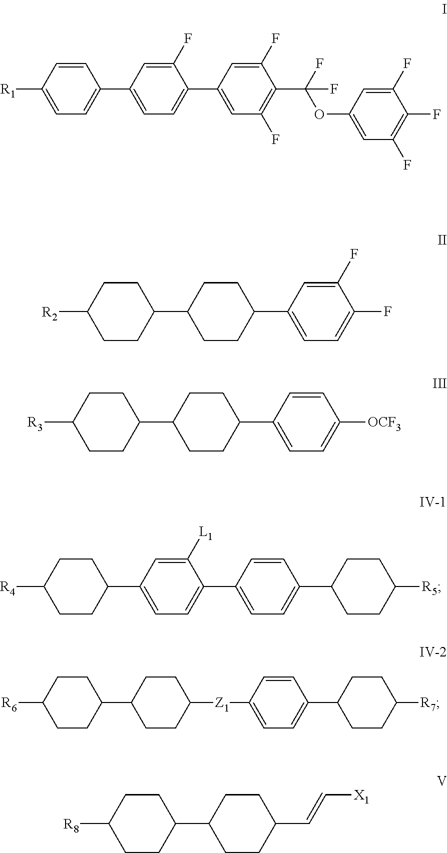

### BACKGROUND OF THE INVENTION

### Field of the Invention

The present invention relates to a liquid crystal composition and a liquid crystal display element, and more particularly, to a liquid crystal composition having good photostability and thermostability, and use of the liquid crystal composition in a liquid crystal display element.

### Description of Related Art

Currently, liquid crystal compounds become more widely used, and are applicable to many types of displays, electro-optic devices, sensors, etc. A wide variety of liquid crystal compounds are available for the above fields, in which nematic liquid crystal compounds is the most widely used. For example, nematic liquid crystal compounds have been applied in passive TN or STN matrix displays and a system with a TFT active matrix.

For TFT-LCD application field, the market has enjoyed tremendous growth and the technology has become more mature; however, the demands for display techniques are rising, especially in terms of high response speed and low drive voltage to reduce power consumption. A liquid crystal material, as one of important optoelectronic materials, plays an important role in improving the performance of a liquid crystal display.

A liquid crystal material is required to have good photostability and thermostability. A liquid crystal material for use in TFT-LCD is also required to have a high nematic-phase upper temperature limit, a high dielectric anisotropy, good anti-UV properties, and a high voltage holding ratio and the like, in addition to the forgoing stability.

In dynamic image display application, the liquid crystal is required to have a high response speed in order to eliminate afterimages and trailing in image display. As a result, the liquid crystal is required to have a low viscosity. In addition, the drive voltage of the liquid crystal are desired to be as low as possible in order to reduce power consumption of the device.

To achieve high quality display, high contrast is another important performance parameter of a liquid crystal display. Contrast is in practice a ratio in brightness, and a liquid crystal composition having a high optical anisotropy can increase the contrast of a liquid crystal display element.

In the related art, there is a problem in which a good compromise between a low viscosity, a suitable optical anisotropy, a suitable dielectric anisotropy, a high response speed, a low drive voltage of a liquid crystal composition cannot be achieved, so that performance indicators of, for example, LCD TVs and tablet PCs cannot be met. Thus, it is required that a liquid crystal composition must have a high clearing point, a low viscosity, good photostability and thermostability, a large dielectric anisotropy, a large optical anisotropy, and good compatibility between liquid crystal compounds.

Any liquid crystal compositions for display are required to have a wide liquid crystal-phase temperature range, a high stability, a low viscosity, and a fast response speed for an electric field. However, no liquid crystal monomer has been used alone in a liquid crystal display so far, so as to satisfy the performance requirements without combination with other compounds.

### SUMMARY OF THE INVENTION

An object of the present invention is to provide a liquid crystal composition which has a large dielectric anisotropy, a large optical anisotropy, a high clearing point, a low viscosity, and good photostability and thermostability simultaneously.

To achieve the above object of the present invention, the present invention provides a liquid crystal composition having good photostability and thermostability, comprising:

5-30% of one or more compounds of general formula I based on the total weight of the liquid crystal composition

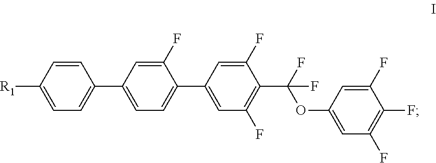

1-30% of one or more compounds of general formula II based on the total weight of the liquid crystal composition

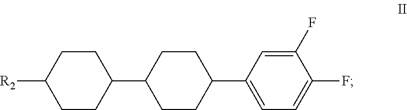

1-30% of one or more compounds of general formula III based on the total weight of the liquid crystal composition

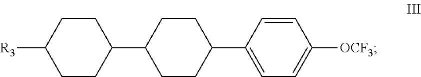

1-20% of one or more compounds of general formula IV-1 and/or IV-2 based on the total weight of the liquid crystal composition

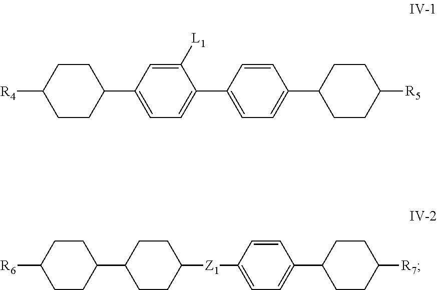

and

15-50% of one or more compounds of general formula V based on the total weight of the liquid crystal composition

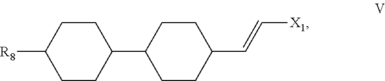

wherein,

R₁, R₂, R₃, R₄, R₅, R₆, R₇, and R₈ are the same or different and are each independently selected from a halogenated or non-halogenated alkyl or alkoxy group having 1 to 10 carbon atoms or a halogenated or non-halogenated alkenyl or alkenyloxy group having 2 to 10 carbon atoms;

L₁ is —H, —F, —Cl, or —CH₃;

Z₁ is a single bond, —COO—, or —OCO—;

X₁ is —H or —CH₃.

In some embodiments of the present invention, R₁, R₂, R₃, R₄, R₅, R₆, R₇, and R₈ are the same or different and are each independently selected from a halogenated or non-halogenated alkyl or alkoxy group having 1 to 5 carbon atoms or a halogenated or non-halogenated alkenyl or alkenyloxy group having 2 to 6 carbon atoms.

In some embodiments of the present invention, L₁ is —H or —F.

In some embodiments of the present invention, Z₁ is a single bond or —COO.

In some embodiments of the present invention, R₁, R₂, R₃, R₄, R₅, R₆, R₇, and R₈ are the same or different and are each independently selected from an alkyl group having 1 to 5 carbon atoms.

In some embodiments of the present invention, L₁ is —H.

In some embodiments of the present invention, Z₁ is —COO—.

In some embodiments of the present invention, the liquid crystal composition further comprises:

0-10% of one or more compounds of general formula VI based on the total weight of the liquid crystal composition:

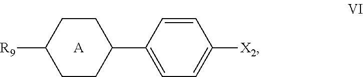

wherein,

R₉ is selected from an alkyl or alkoxy group having 1 to 10 carbon atoms or an alkenyl or alkenyloxy group having 2 to 10 carbon atoms;

X₂ is selected from —F, —OCF₃, an alkyl or alkoxy group having 1 to 5 carbon atoms, or an alkenyl or alkenyloxy group having 2 to 6 carbon atoms;

ring

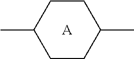

is

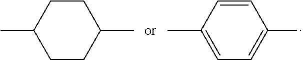

In some embodiments of the present invention, R₉ is selected from an alkyl group having 1 to 10 carbon atoms.

In some embodiments of the present invention, X₂ is —F.

In some embodiments of the present invention, ring

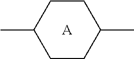

is

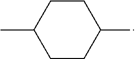

In some embodiments of the present invention, the liquid crystal composition further comprises:

0-30% of one or more compounds of general formula VII based on the total weight of the liquid crystal composition:

wherein,

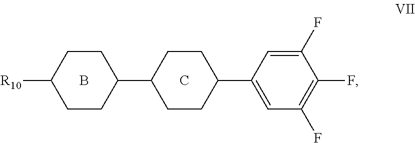

R₁₀ is selected from an alkyl or alkoxy group having 1 to 10 carbon atoms or an alkenyl or alkenyloxy group having 2 to 10 carbon atoms;

ring

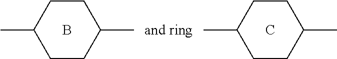

are the same or different and are each independently selected from

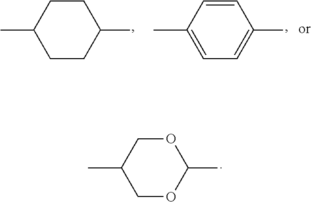

In embodiments of the present invention, the compound of general formula I comprises 10-25% of the total weight of the liquid crystal composition; the compound of general formula II comprises 5-25% of the total weight of the liquid crystal composition; the compound of general formula III comprises 5-25% of the total weight of the liquid crystal composition; the compound of general formula IV-1 and/or IV-2 comprises 1-10% of the total weight of the liquid crystal composition; the compound of general formula V comprises 20-45% of the total weight of the liquid crystal composition; the compound of general formula VI comprises 0-10% of the total weight of the liquid crystal composition; and the compound of general formula VI comprises 0-30% of the total weight of the liquid crystal composition.

In some embodiments of the present invention, the compound of general formula I is selected from compounds I-1 to I-5:

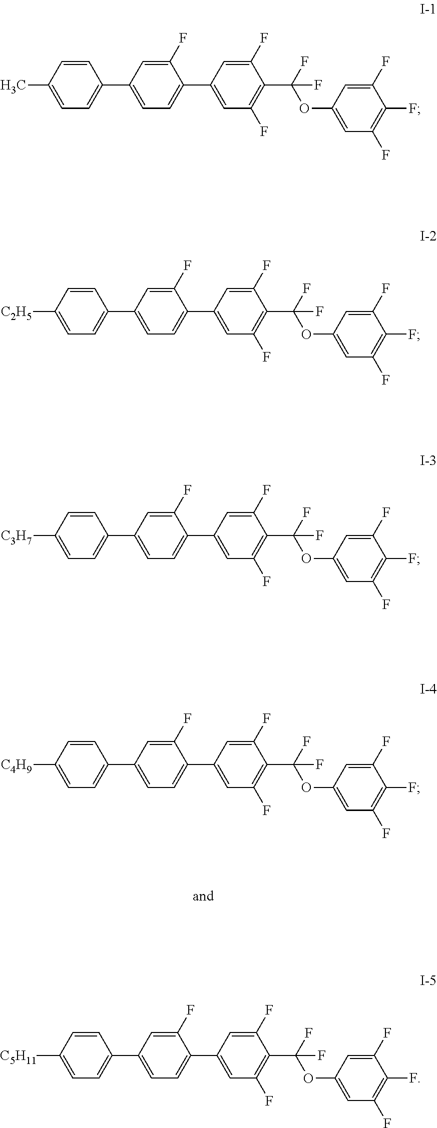

In some embodiments of the present invention, the compound of general formula II is selected from compounds II-1 to II-5:

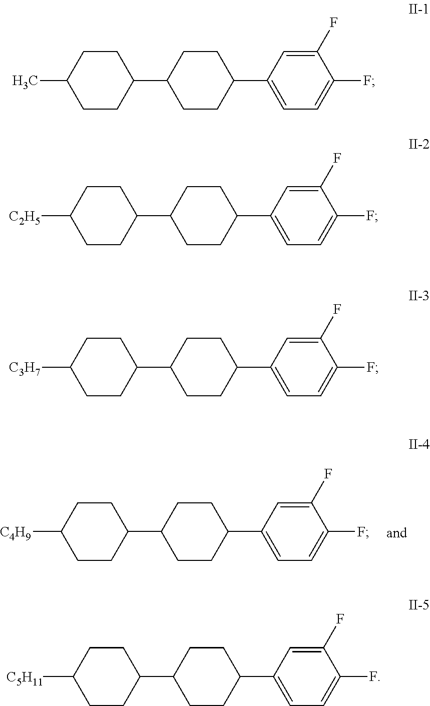

In some embodiments of the present invention, the compound of general formula III is selected from compounds III-1 to III-5:

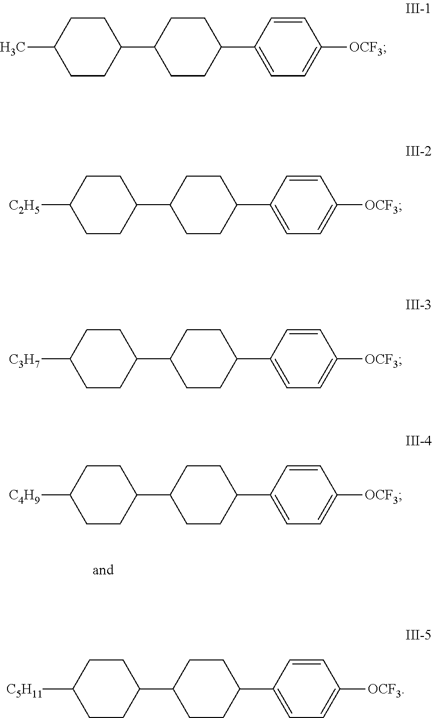

In some embodiments of the present invention, the compound of general formula IV-1 is selected from compounds IV-1-1 to IV-1-10:

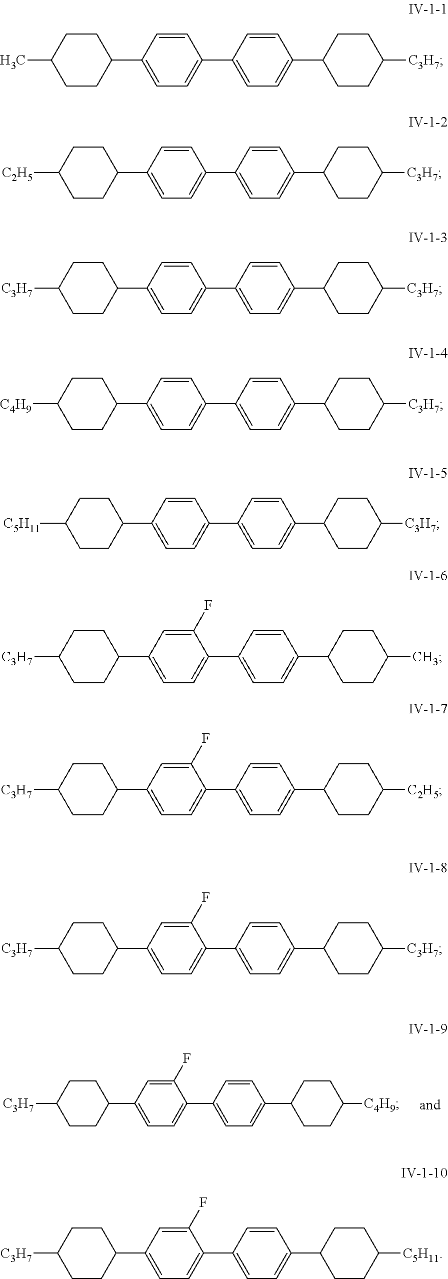

In some embodiments of the present invention, the compound of general formula IV-2 is selected from compounds IV-2-1 to IV-2-10:

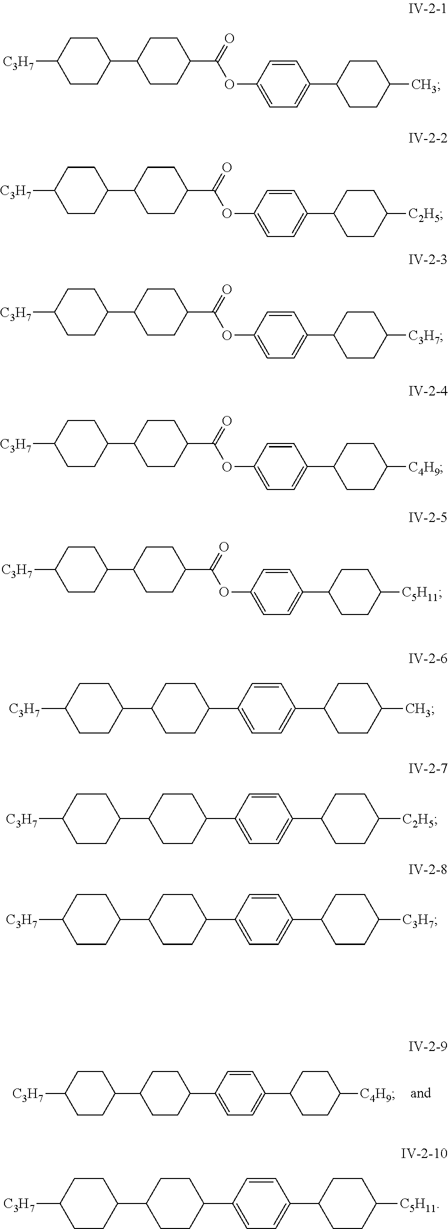

In some embodiments of the present invention, the compound of general formula V is selected from compounds V-1 to V-6:

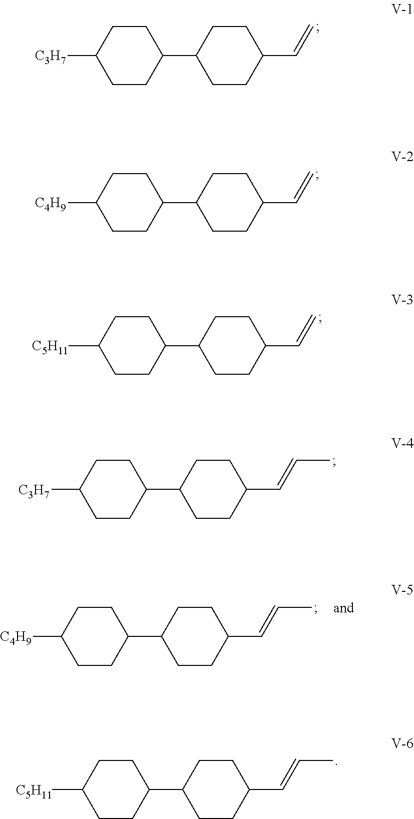

In some embodiments of the present invention, the compound of general formula VI is selected from compounds VI-1 to VI-10:

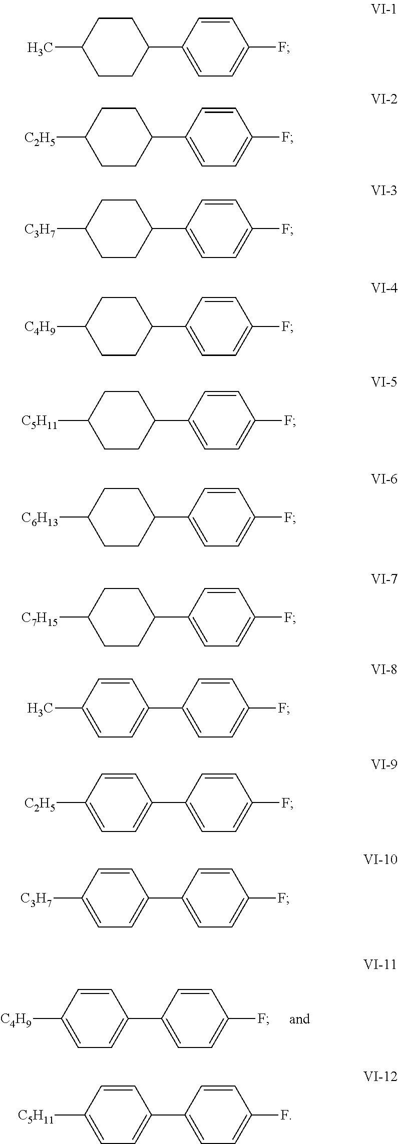

In some embodiments of the present invention, the compound of general formula VII is selected from compounds VII-1 to VII-2:

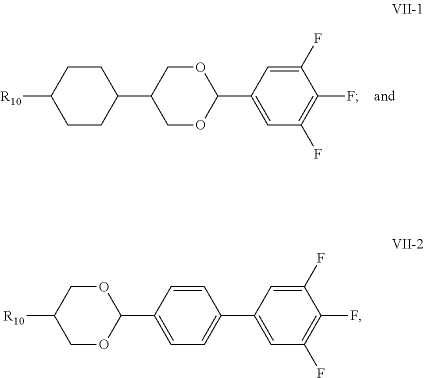

wherein,

R₁₀ is selected from an alkyl or alkoxy group having 1 to 5 carbon atoms or an alkenyl or alkenyloxy group having 2 to 6 carbon atoms.

In some embodiments of the present invention, R₁₀ is selected from an alkyl group having 1 to 5 carbon atoms.

In some embodiments of the present invention, the compound of general formula VII-1 is selected from compounds VII-1-1 to VII-1-5:

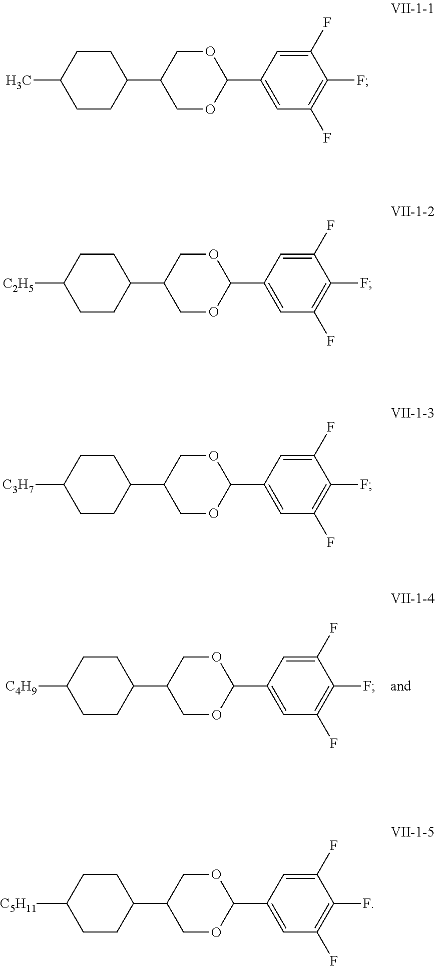

In some embodiments of the present invention, the compound of general formula VII-2 is selected from compounds VII-2-1 to VII-2-5:

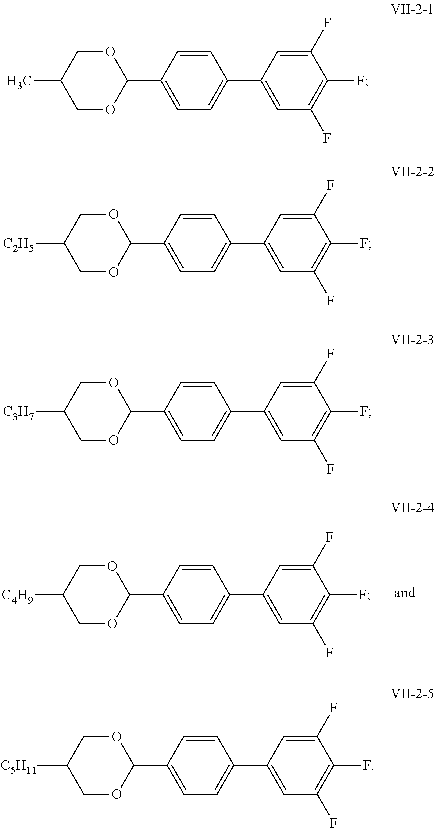

The liquid crystal composition of the present invention does not comprises a compound of general formula VIII:

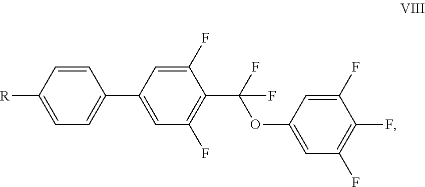

wherein,

R is selected from a halogenated or non-halogenated alkyl or alkoxy group having 1 to 10 carbon atoms or a halogenated or non-halogenated alkenyl or alkenyloxy group having 2 to 10 carbon atoms.

Also provided is a liquid crystal display element containing the liquid crystal composition.

Compared with the prior art, the liquid crystal composition of the present invention has better photostability and thermostability, a large dielectric anisotropy, a lower viscosity, a higher clearing point, and an appropriately high optical anisotropy, and is suitable for use in a liquid crystal display element.

### DETAILED DESCRIPTION OF THE INVENTION

The present invention will be described below in connection with specific embodiments. It is noted that the following examples are merely illustrative of the invention and are not intended to be limiting. Other combinations and various modifications can be made based on the concept of the invention without departing from the spirit or scope of the invention.

For convenience of expression, in the following examples, the group structures of the liquid crystal composition are represented by codes listed in Table 1:

TABLE 1
Codes for group structures in liquid crystal compounds

| Unit structure of the group | Code | Name of the group |
|---|---|---|
| 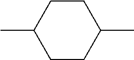 | C | 1,4-cyclohexylene |
| 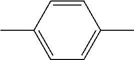 | P | 1,4-phenylene |
| 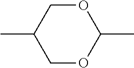 | D | 1,4-dioxanyl |
| 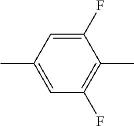 | U | 2,5-difluoro-1,4-phenylene |
| —CN | N | Cyano |
| —CH₂CH₂— | 2 | Ethylene |
| —OCF₃ | OCF₃ | Trifluoromethoxy |
| —F | F | Fluoro substituent |
| —O— | O | Oxy substituent |
| —CF₂O— | Q | Difluoromethyloxy |
| —COO— | E | Ester linkage |
| —CH₂O— | 10 | Methyleneoxy |
| —CₙH₂ₙ₊₁ or —CₘH₂ₘ₊₁ | n or m | Alkyl |
| —CH═CH— or —CH═CH₂ | V | Vinyl |
| —C≡C— or —C≡CH | T | Ethynyl |

A compound of the following formula is taken as an example:

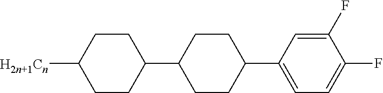

With the codes listed in Table 1, the structural formula may be expressed as nCCGF, in which n represents the number of C atoms of the alkyl at the left end and is, for example, “3”, indicating that the alkyl is —C₃H₇; and C represents cyclohexyl.

The test items in the following examples are abbreviated as follows:

Cp: clearing point (nematic-isotropic phase transition temperature, ° C.)

Δε: dielectric anisotropy (1 KHz, 25° C.)

Δn: optical anisotropy (589 nm, 20° C.)

VHR (100° C.): voltage holding ratio after being maintained at a high temperature of 100° C. for 1 h (%)

VHR (UV): voltage holding ratio after 20 min of irradiation by a UV lamp (%)

η: kinetic viscosity (mm²·s−¹, 25° C., unless otherwise noted)

The optical anisotropy is measured using an Abbe refractometer under a sodium lamp (589 nm) as a light source at 20° C. The dielectric test cell is the type TN90, and the cell gap is 7 μm.

VHR (UV) is tested by TOY06254 liquid crystal physical property evaluation system, where the test cell is irradiated by a UV lamp for 20 min (365 nm, 5 mW/cm²) and cooled to room temperature, the test temperature is 25° C., and the test cycle is 166.7 ms.

VHR (100° C.) is tested using TOY06254 liquid crystal physical property evaluation system, where the test temperature is 100° C., and the test cycle is 166.7 ms.

Each of the components used in the following examples can be synthesized using a known method or using an appropriate combination of methods in organic synthesis chemistry, by the inventors of this application. These synthesis techniques are conventional and the resulting liquid crystal compounds are tested to conform to the standards for electronic compounds. Methods for introducing a target terminal group, a ring structure and a binding group into a starting material are described in Organic Syntheses, John Wiley & Sons, Inc; Organic Reactions, John Wiley & Sons, Inc; Comprehensive Organic Synthesis, Pergamon Press; New Experimental Chemistry Course (MARUZEN CO., LTD), and other publications.

A liquid crystal composition is prepared according to a mixing ratio of the liquid crystal compositions defined in the following examples. The liquid crystal composition is prepared by a conventional method in the art, for example, mixing according to the defined ratio by heating, ultrasonicating, and suspending, etc.

The liquid crystal compositions given in the following examples are prepared and investigated. Composition and performance test results of each liquid crystal composition are shown below.

Each of the liquid crystal displays used in the following embodiments is a TFT liquid crystal display device, having a cell gap of d=7 μm and including polarizers and electrode substrates. The display device is in a normally white mode, that is, the color of a pixel seen by a viewer is white when no voltage is applied across row electrodes and column electrodes. Upper polarizer axis and lower polarizer axis on the substrates are at a 90-degree angle with respect to each other. An optical liquid crystal material is filled into a space between the two substrates.

The composition, mixing ratio and test result of the liquid crystal compositions of comparative examples when filled in two substrate of the liquid crystal display device for peformance test are listed in Tables 2 and 7, for comparison in performance with the liquid crystal compositions of the present invention.

### COMPARATIVE EXAMPLE 1

The liquid crystal composition of Comparative Example 1 was prepared with the compounds in percentages by weight shown in Table 2, filled between two substrates of a liquid crystal display, and subjected to performance test. The test data is shown in the table below.

TABLE 2
Formulation of liquid crystal composition and performances tested

| | | | |
|---|---|---|---|
| Code of | Code of | Percentage | Test result of |
| component | structure | by weight | performance parameters |

| 3PUQUF | 6 | Cp | 90.2 |
|---|---|---|---|
| 2CPUQUF | 9 | Δ∈ | 10.2 |
| 3CPUQUF | 9 | Δn | 0.103 |
| 3C2CUF | 12 | η | 32.8 |
| 4C2CUF | 9 | VHR (100° C.) | 95.2% |
| 5C2CUF | 9 | VHR (UV) | 90.7% |
| 3CCUF | 7 | | |
| 4CCUF | 5 | | |
| 3CC2UF | 15 | | |
| 3CPUF | 6 | | |
| 5CPUF | 4 | | |
| 3CGUF | 4 | | |
| 2CCCUF | 2 | | |
| 3CCCUF | 3 | | |
| Total | 100 | | |

### EXAMPLE 1

The liquid crystal composition of Example 1 was prepared with the compounds in percentages by weight shown in Table 3, filled between two substrates of a liquid crystal display, and subjected to performance test. The test data is shown in the table below.

TABLE 3
Formulation of liquid crystal composition and performances tested

| Code of | Code of | Percentage | Test result of | |
|---|---|---|---|---|
| component | structure | by weight | performance parameters | |
| 3CCGF | II-3 | 8 | Cp | 95.9 |
| 4CCGF | II-4 | 7 | Δ∈ | 10.1 |
| 5CCGF | II-5 | 5 | Δn | 0.105 |
| 2CCGF | II-2 | 1 | η | 18 |
| 2CCPOCF3 | III-2 | 6 | VHR (100° C.) | 96.5% |
| 3CCPOCF3 | III-3 | 9 | VHR (UV) | 96.1% |
| 4CCPOCF3 | III-4 | 4 | | |
| 3PGUQUF | I-3 | 6.5 | | |
| 4PGUQUF | I-4 | 7 | | |
| 5PGUQUF | I-5 | 7 | | |
| 2PGUQUF | I-2 | 4 | | |
| 3CPPC3 | IV-1-3 | 1.5 | | |
| 3CGPC3 | IV-1-8 | 2 | | |
| 3CCV1 | V-4 | 9 | | |
| 3CCV | V-1 | 23 | | |

| | |
|---|---|
| Total | 100 |

### EXAMPLE 2

The liquid crystal composition of Example 2 was prepared with the compounds in percentages by weight shown in Table 4, filled between two substrates of a liquid crystal display, and subjected to performance test. The test data is shown in the table below.

TABLE 4
Formulation of liquid crystal composition and performances tested

| | | | | Test result |
|---|---|---|---|---|
| Code of | Code of | Percentage | | of performance |
| component | structure | by weight | | parameters |
| 3CCGF | II-3 | 9 | Cp | 100.1 |
| 4CCGF | II-4 | 8 | Δ∈ | 10.8 |
| 5CCGF | II-5 | 5 | Δn | 0.107 |
| 2CCGF | II-2 | 3 | η | 19 |
| 2CCPOCF3 | III-2 | 6 | VHR (100° C.) | 96.2% |
| 3CCPOCF3 | III-3 | 9 | VHR (UV) | 96.0% |
| 4CCPOCF3 | III-4 | 4 | | |
| 3PGUQUF | I-3 | 6 | | |
| 4PGUQUF | I-4 | 7 | | |
| 5PGUQUF | I-5 | 6 | | |
| 2PGUQUF | I-2 | 4 | | |
| 3CPPC3 | IV-1-3 | 1.5 | | |
| 3CPPC5 | IV-1-5 | 2 | | |
| 3CCEPC3 | IV-2-3 | 3.5 | | |
| 3CCV1 | V-4 | 5 | | |
| 3CCV | V-1 | 16 | | |
| 7CPF | VI-7 | 5 | | |

| | |
|---|---|
| Total | 100 |

### EXAMPLE 3

The liquid crystal composition of Example 3 was prepared with the compounds in percentages by weight shown in Table 5, filled between two substrates of a liquid crystal display, and subjected to performance test. The test data is shown in the table below.

TABLE 5
Formulation of liquid crystal composition and performances tested

| Code of | Code of | Percentage | Test result of | |
|---|---|---|---|---|
| component | structure | by weight | performance parameters | |
| 3CCGF | II-3 | 4 | Cp | 95.9 |
| 4CCGF | II-4 | 4 | Δ∈ | 10.7 |
| 5CCGF | II-5 | 3 | Δn | 0.1 |
| 2CCGF | II-2 | 2 | η | 22 |
| 2CCPOCF3 | III-2 | 5 | VHR (100° C.) | 96.2% |
| 3CCPOCF3 | III-3 | 3 | VHR (UV) | 96.8% |
| 4CCPOCF3 | III-4 | 5 | | |
| 3PGUQUF | I-3 | 4 | | |
| 4PGUQUF | I-4 | 3 | | |
| 5PGUQUF | I-5 | 4 | | |
| 3CPPC3 | IV-1-3 | 1.5 | | |
| 3CGPC3 | IV-1-8 | 2 | | |
| 3CPPC5 | IV-1-5 | 2 | | |
| 3CCV1 | V-4 | 11 | | |
| 3CCV | V-1 | 19.5 | | |
| 3DPUF | VII-2-3 | 4 | | |
| 4DPUF | VII-2-4 | 5 | | |
| 3CDUF | VII-1-3 | 9 | | |
| 5CDUF | VII-1-5 | 9 | | |

| | |
|---|---|
| Total | 100 |

### EXAMPLE 4

The liquid crystal composition of Example 4 was prepared with the compounds in percentages by weight shown in Table 6, filled between two substrates of a liquid crystal display, and subjected to performance test. The test data is shown in the table below.

TABLE 6
Formulation of liquid crystal composition and performances tested

| Code of | Code of | Percentage | Test result of | |
|---|---|---|---|---|
| component | structure | by weight | performance parameters | |
| 3CCGF | II-3 | 9 | Cp | 109.4 |
| 4CCGF | II-4 | 8 | Δ∈ | 10.5 |
| 5CCGF | II-5 | 5 | Δn | 0.107 |
| 2CCGF | II-2 | 3 | η | 22 |
| 2CCPOCF3 | III-2 | 6 | VHR (100° C.) | 96.3% |
| 3CCPOCF3 | III-3 | 9 | VHR (UV) | 96.0% |
| 4CCPOCF3 | III-4 | 4 | | |
| 5CCPOCF3 | III-5 | 6 | | |
| 3PGUQUF | I-3 | 5.5 | | |
| 4PGUQUF | I-4 | 7 | | |
| 5PGUQUF | I-5 | 5.5 | | |
| 2PGUQUF | I-2 | 3.5 | | |
| 3CPPC3 | IV-1-3 | 1.5 | | |
| 3CPPC5 | IV-1-5 | 2 | | |
| 3CCEPC3 | IV-2-3 | 3.5 | | |
| 3CCEPC5 | IV-2-5 | 1.5 | | |
| 4CCV | V-2 | 5 | | |
| 5CCV | V-3 | 5 | | |
| 3CCV | V-1 | 10 | | |

| | |
|---|---|
| Total | 100 |

### EXAMPLE 5

The liquid crystal composition of Example 5 was prepared with the compounds in percentages by weight shown in Table 7, filled between two substrates of a liquid crystal display, and subjected to performance test. The test data is shown in the table below.

TABLE 7
Formulation of liquid crystal composition and performances tested

| Code of | Code of | Percentage | Test result of | |
|---|---|---|---|---|
| component | structure | by weight | performance parameters | |
| 3CCGF | II-3 | 6 | Cp | 100.2 |
| 4CCGF | II-4 | 6 | Δ∈ | 10.1 |
| 5CCGF | II-5 | 5 | Δn | 0.101 |
| 2CCGF | II-2 | 4 | η | 20 |
| 2CCPOCF3 | III-2 | 5 | VHR (100° C.) | 96.2% |
| 3CCPOCF3 | III-3 | 3 | VHR (UV) | 96.5% |
| 4CCPOCF3 | III-4 | 5 | | |
| 5CCPOCF3 | III-5 | 4 | | |
| 3PGUQUF | I-3 | 5 | | |
| 4PGUQUF | I-4 | 6 | | |
| 5PGUQUF | I-5 | 6 | | |
| 3CPPC3 | IV-1-3 | 1.5 | | |
| 3CGPC3 | IV-1-8 | 2 | | |
| 3CPPC5 | IV-1-5 | 2 | | |
| 3CCV1 | V-4 | 11 | | |
| 3CCV | V-1 | 25.5 | | |
| 3CDUF | VII-1-3 | 3 | | |

| | |
|---|---|
| Total | 100 |

### COMPARATIVE EXAMPLE 2

The liquid crystal composition of Example 1, prepared with the compounds in percentages by weight shown in Table 3, was mixed with the compound 3PUQUF in a ratio of 95:5, 90:10 and 85:15 to give the liquid crystal compositions M1, M2 and M3 respectively. The liquid crystal compositions M1, M2 and M3 were filled into two substrate of the liquid crystal display device for performance test. The test data is shown in Table 7 below:

TABLE 7

| | M1 | M2 | M3 |
|---|---|---|---|
| VHR (100° C.) | 96.5% | 96.5% | 96.5% |
| VHR (UV) | 93.3% | 91.4% | 81.8% |

It can be seen from the data in Table 7 that the VHR value of the liquid crystal composition after UV irradiation decreases with increase in 3PUQUF content, indicating that 3PUQUF can decrease the UV stability of the liquid crystal composition.

It can be known from the performance parameters of the liquid crystal compositions shown in Comparative Example 1, Comparative Example 2 and Examples 1-5 that, the liquid crystal compositions of the present invention have a higher dielectric anisotropy, a suitable optical anisotropy, a lower viscosity, good photostability and thermostability, and a higher clearing point, and are particularly suitable for use in liquid crystal display elements such as TFT driven by AM driving.

The above merely describes preferred embodiments of the present invention, and is not intended to limit the present invention in any way. Although the present invention has been disclosed above with reference to the preferred embodiments, the present invention is not limited thereto. Without departing from the scope of the technical solutions of the present invention, any person skilled in the art can make variations or modifications to form equivalent embodiments according to the technical content disclosed above. Any simple variations, equivalent changes and modifications made to the foregoing embodiments according to the technical essence of the present invention without departing from the content of the technical solutions of the present invention shall fall within the scope of the technical solutions of the present invention.

1. A liquid crystal composition, comprising:
5-30% of one or more compounds of general formula I based on a total weight of the liquid crystal composition 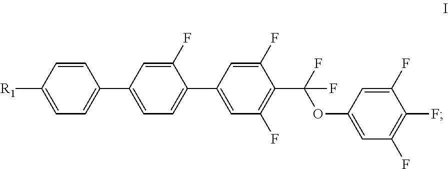
1-30% of one or more compounds of general foimula II based on the total weight of the liquid crystal composition 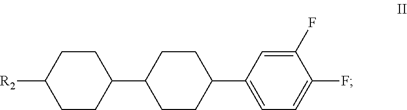
1-30% of one or more compounds of general foimula III based on the total weight of the liquid crystal composition 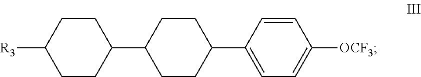
1-20% of one or more compounds of general formula IV-1 and/or IV-2 based on the total weight of the liquid crystal composition 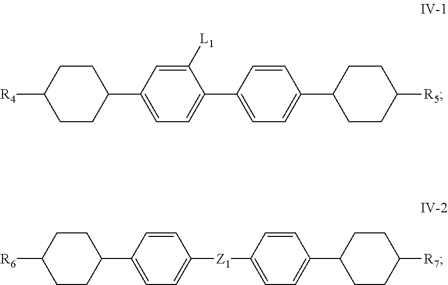
and
15-50% of one or more compounds of general formula V based on the total weight of the liquid crystal composition 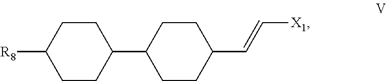
and
the liquid crystal composition does not comprises a compound of general formula VIII: 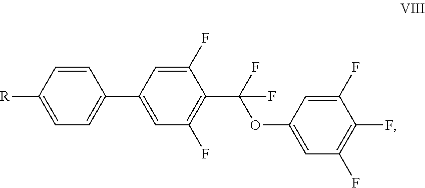
wherein,
R, R₁, R₂, R₃, R₄, R₅, R₆, R₇, and R₈ are the same or different and are each independently selected from a halogenated or non-halogenated alkyl or alkoxy group having 1 to 10 carbon atoms or a halogenated or non-halogenated alkenyl or alkenyloxy group having 2 to 10 carbon atoms;
L₁ is —H, —F, —Cl, or —CH₃;
Z₁ is a single bond, —COO—, or —OCO—;
X₁ is —H or —CH₃.

2. The liquid crystal composition according to claim 1, further comprising: one or more compounds of general formula VI, wherein an amount of the one or more compounds of general formula VI based on the total weight of the liquid crystal composition is greater than 0% and less than or equal to 10%, 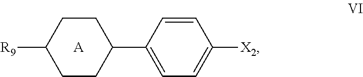
wherein,
R₉ is selected from an alkyl or alkoxy group having 1 to 10 carbon atoms or an alkenyl or alkenyloxy group having 2 to 10 carbon atoms;
X₂ is selected from —F, —OCF₃, an alkyl or alkoxy group having 1 to 5 carbon atoms, or an alkenyl or alkenyloxy group having 2 to 6 carbon atoms;
ring 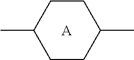
is

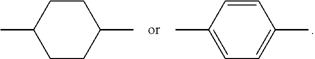

3. The liquid crystal composition according to claim 2, further comprising: one or more compounds of general formula VII, wherein an amount of the one or more compounds of general formula VII based on the total weight of the liquid crystal composition is greater than 0% and less than or equal to 30%, 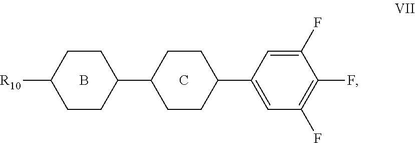
wherein,
R₁₀ is selected from an alkyl or alkoxy group having 1 to 10 carbon atoms or an alkenyl or alkenyloxy group having 2 to 10 carbon atoms;
ring 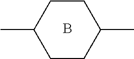
and ring 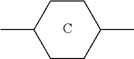
are the same or different and are each independently selected from

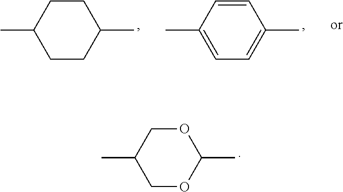

4. The liquid crystal composition according to claim 1, wherein the compound of general formula I is selected from compounds I-1 to I-5:

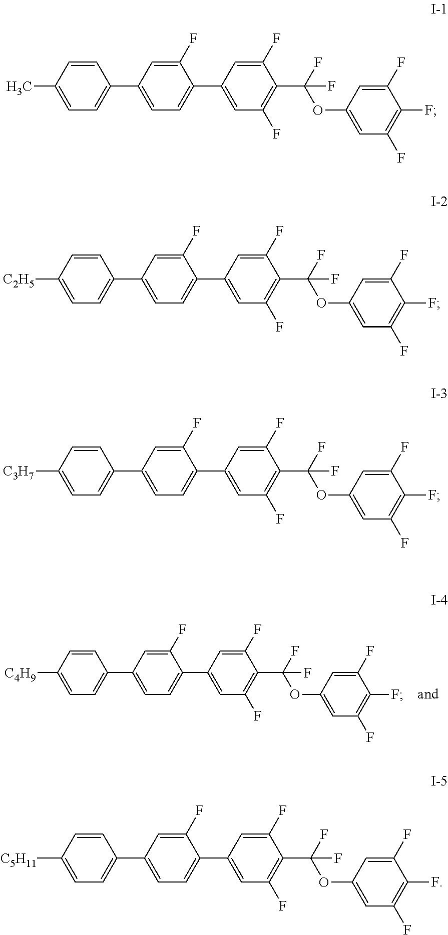

5. The liquid crystal composition according to claim 1, wherein the compound of general formula II is selected from compounds II-1 to II-5:

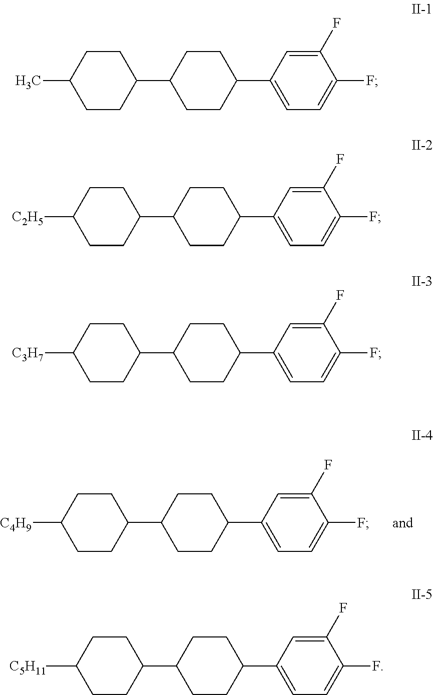

6. The liquid crystal composition according to claim 1, wherein the compound of general formula III is selected from compounds III-1 to III-5:

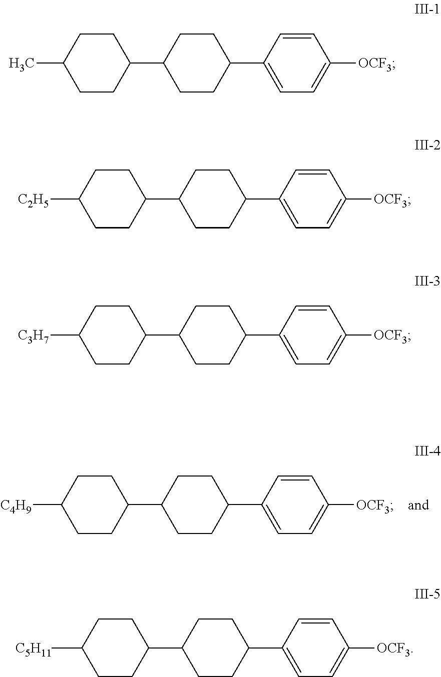

7. The liquid crystal composition according to claim 1, wherein the compound of general formula N-1 is selected from compounds IV-1-1 to IV-1-10: 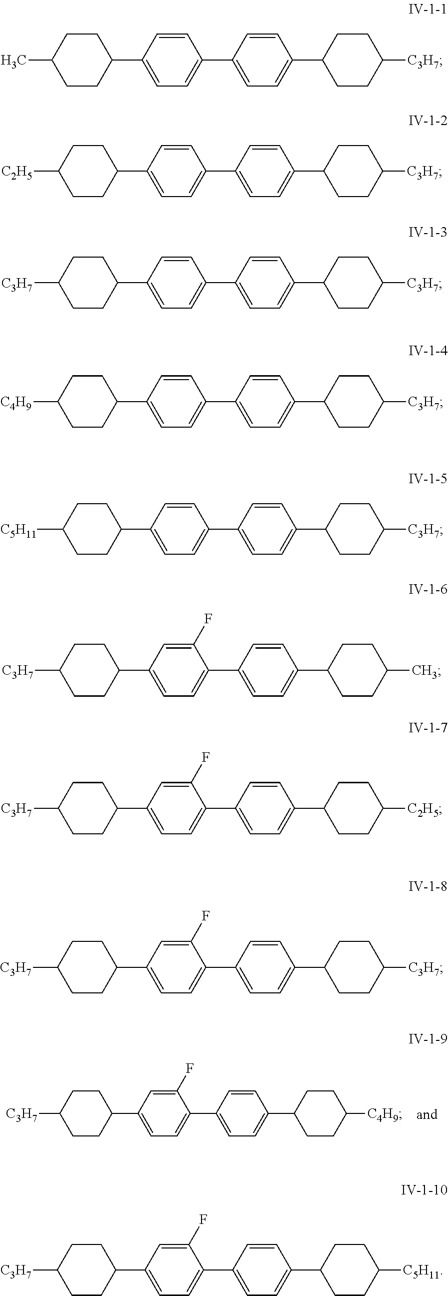
the compound of general formula IV-2 is selected from compounds IV-2-1 to IV-2-10:

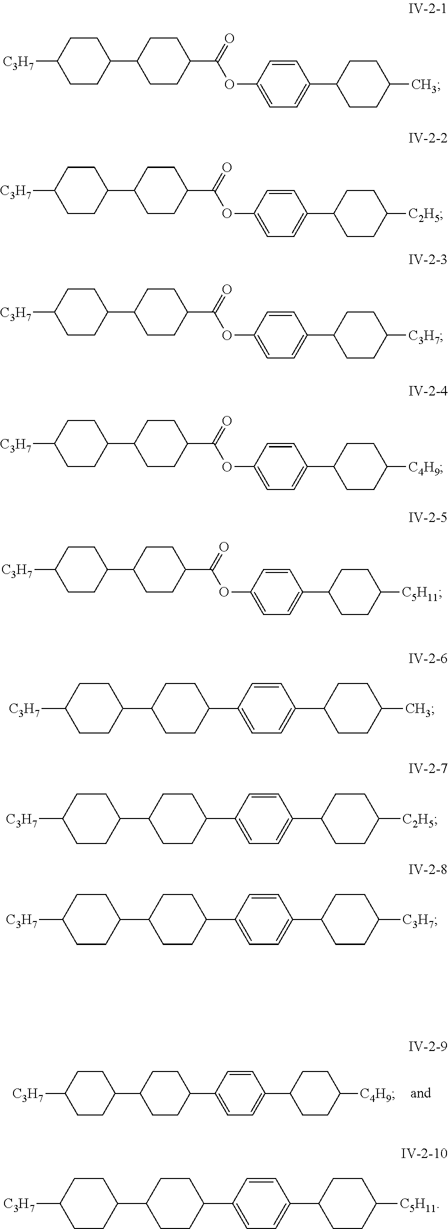

8. The liquid crystal composition according to claim 1, wherein the compound of general formula V is selected from compounds V-1 to V-6:

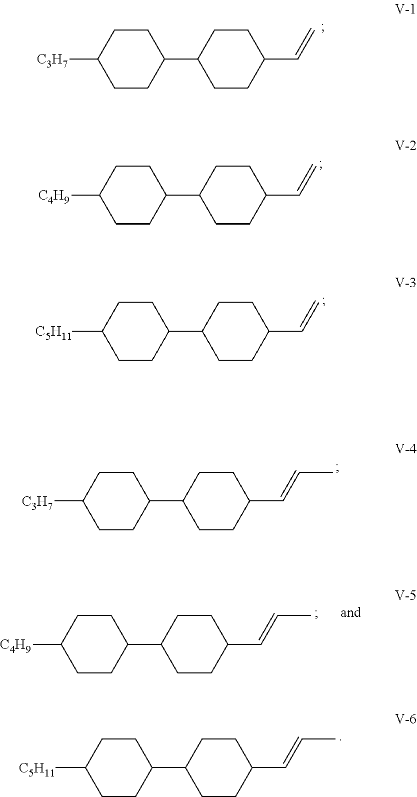

9. The liquid crystal composition according to claim 2, wherein the compound of general formula VI is selected from compounds VI-1 to VI-10:

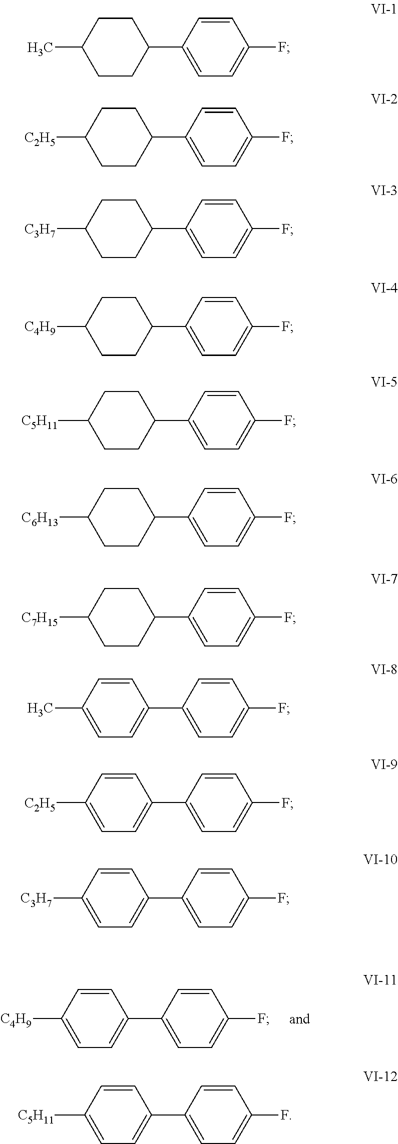

10. The liquid crystal composition according to claim 3, wherein the compound of general formula VII is selected from compounds of general formulas VII-1 to VII-2: 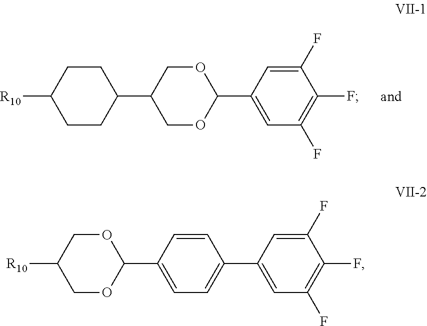
wherein,
R₁₀ is selected from an alkyl or alkoxy group having 1 to 5 carbon atoms or an alkenyl or alkenyloxy group having 2 to 6 carbon atoms.

11. The liquid crystal composition according to claim 10, wherein the compound of general formula VII-1 is selected from compounds VII-1-1 to VII-1-5: 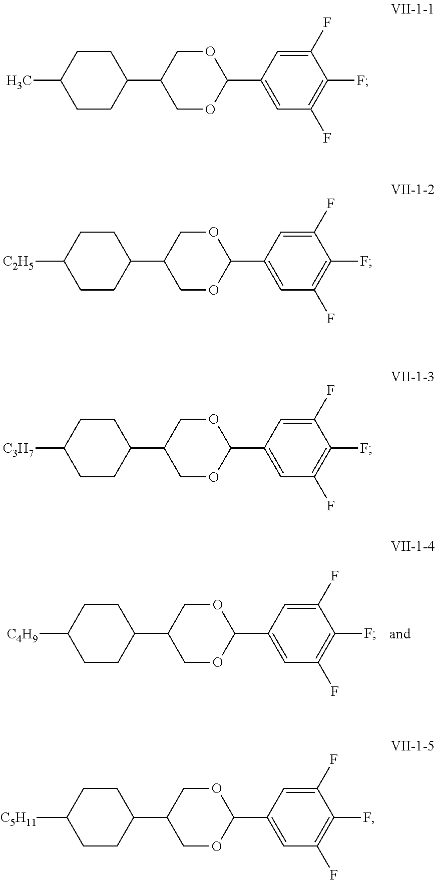
the compound of general formula VII-2 is selected from compounds VII-2-1 to VII-2-5:

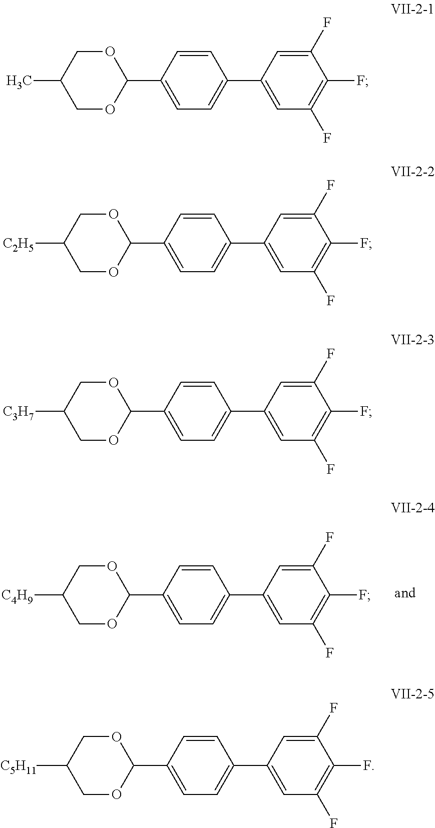

12. The liquid crystal composition according to claim 1, wherein the liquid crystal composition comprises:
8% of the compound II-3 based on the total weight of the liquid crystal composition 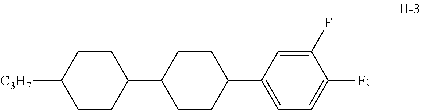
7% of the compound II-4 based on the total weight of the liquid crystal composition 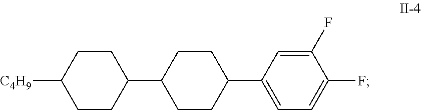
5% of the compound II-5 based on the total weight of the liquid crystal composition 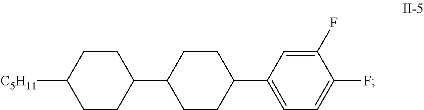
1% of the compound II-2 based on the total weight of the liquid crystal composition 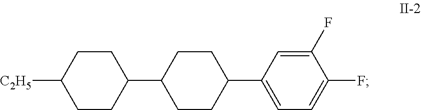 [SMILES: CCC1CCC(C2CCC(c3ccc(F)c(F)c3)CC2)CC1]
6% of the compound III-2 based on the total weight of the liquid crystal composition 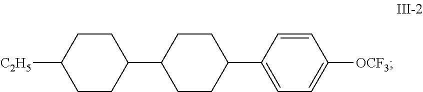 [SMILES: CCC1CCC(C2CCC(c3ccc(OC(F)(F)F)cc3)CC2)CC1]
9% of the compound III-3 based on the total weight of the liquid crystal composition 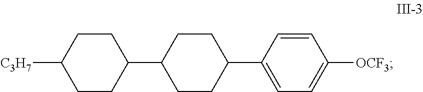
4% of the compound III-4 based on the total weight of the liquid crystal composition 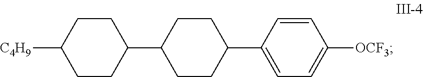
6.5% of the compound I-3 based on the total weight of the liquid crystal composition 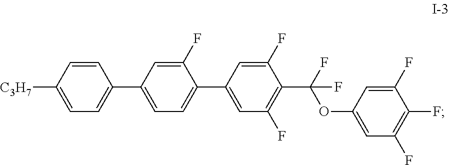
7% of the compound I-4 based on the total weight of the liquid crystal composition 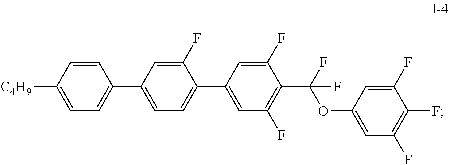
7% of the compound I-5 based on the total weight of the liquid crystal composition 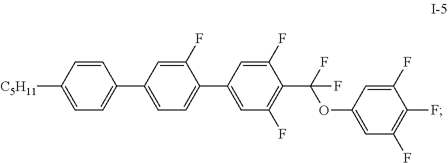
4% of the compound I-2 based on the total weight of the liquid crystal composition 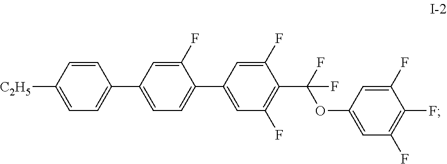 [SMILES: CCc1ccc(-c2ccc(-c3cc(F)c(C(F)(F)Oc4cc(F)c(F)c(F)c4)c(F)c3)c(F)c2)cc1]
1.5% of the compound IV-1-3 based on the total weight of the liquid crystal composition 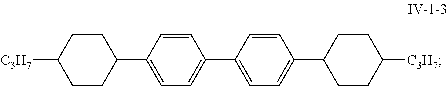
2% of the compound IV-1-8 based on the total weight of the liquid crystal composition 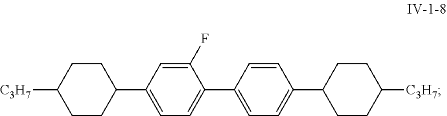
9% of the compound V-4 based on the total weight of the liquid crystal composition 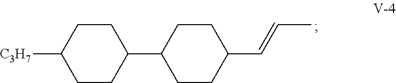
and
23% of the compound V-1 based on the total weight of the liquid crystal composition 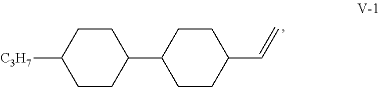
or the liquid crystal composition comprises:
9% of the compound II-3 based on the total weight of the liquid crystal composition 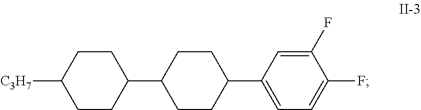
8% of the compound II-4 based on the total weight of the liquid crystal composition 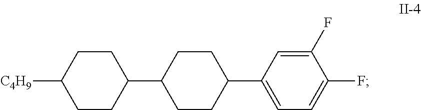
5% of the compound II-5 based on the total weight of the liquid crystal composition 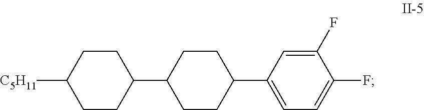
3% of the compound II-2 based on the total weight of the liquid crystal composition 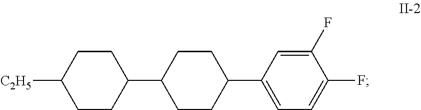 [SMILES: CCC1CCC(C2CCC(c3ccc(F)c(F)c3)CC2)CC1]
6% of the compound III-2 based on the total weight of the liquid crystal composition 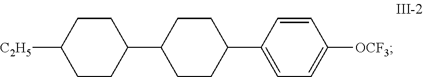 [SMILES: CCC1CCC(C2CCC(c3ccc(OC(F)(F)F)cc3)CC2)CC1]
9% of the compound III-3 based on the total weight of the liquid crystal composition 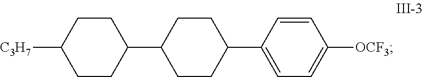
4% of the compound III-4 based on the total weight of the liquid crystal composition 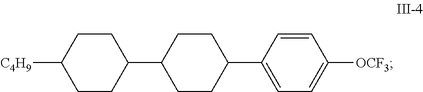
6% of the compound I-3 based on the total weight of the liquid crystal composition 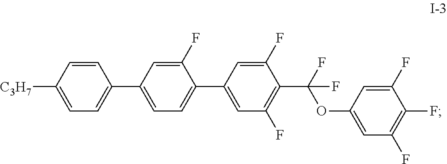
7% of the compound I-4 based on the total weight of the liquid crystal composition 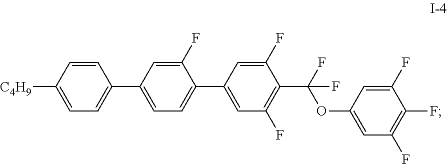
6% of the compound I-5 based on the total weight of the liquid crystal composition 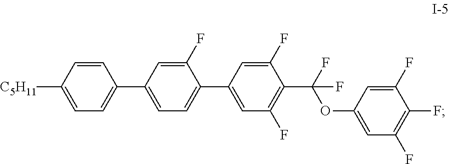
4% of the compound I-2 based on the total weight of the liquid crystal composition 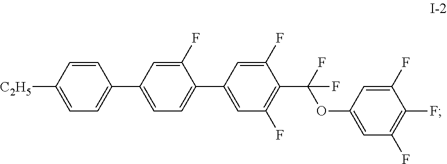 [SMILES: CCc1ccc(-c2ccc(-c3cc(F)c(C(F)(F)Oc4cc(F)c(F)c(F)c4)c(F)c3)c(F)c2)cc1]
1.5% of the compound IV-1-3 based on the total weight of the liquid crystal composition 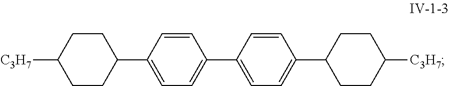
2% of the compound IV-1-5 based on the total weight of the liquid crystal composition 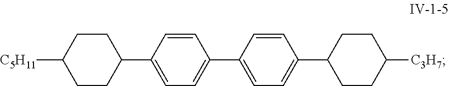
3.5% of the compound IV-2-3 based on the total weight of the liquid crystal composition 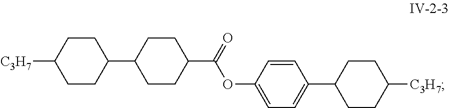
5% of the compound V-4 based on the total weight of the liquid crystal composition 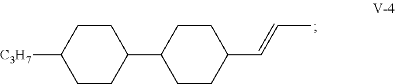
16% of the compound V-1 based on the total weight of the liquid crystal composition 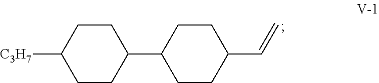
and
5% of the compound VI-7 based on the total weight of the liquid crystal composition 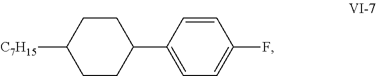
or the liquid crystal composition comprises:
4% of the compound II-3 based on the total weight of the liquid crystal composition 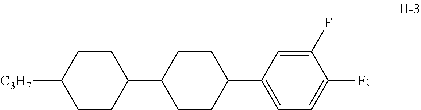
4% of the compound II-4 based on the total weight of the liquid crystal composition 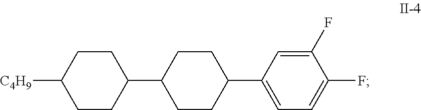
3% of the compound II-5 based on the total weight of the liquid crystal composition 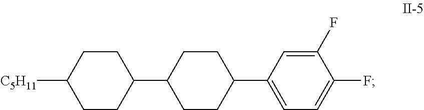
2% of the compound II-2 based on the total weight of the liquid crystal composition 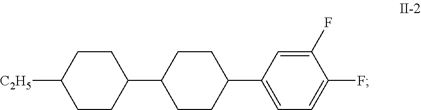 [SMILES: CCC1CCC(C2CCC(c3ccc(F)c(F)c3)CC2)CC1]
5% of the compound III-2 based on the total weight of the liquid crystal composition 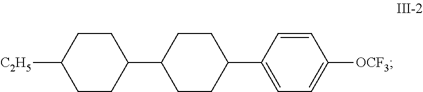 [SMILES: CCC1CCC(C2CCC(c3ccc(OC(F)(F)F)cc3)CC2)CC1]
3% of the compound III-3 based on the total weight of the liquid crystal composition 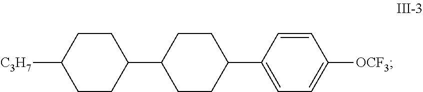
5% of the compound III-4 based on the total weight of the liquid crystal composition 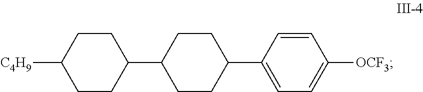
4% of the compound I-3 based on the total weight of the liquid crystal composition 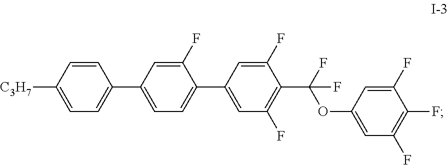
3% of the compound I-4 based on the total weight of the liquid crystal composition 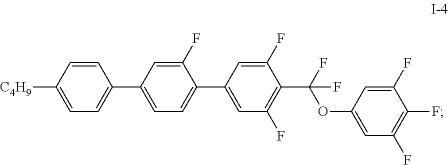
4% of the compound I-5 based on the total weight of the liquid crystal composition 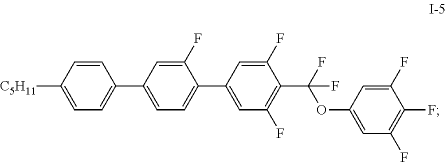
1.5% of the compound IV-1-3 based on the total weight of the liquid crystal composition 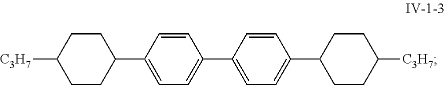
2% of the compound IV-1-8 based on the total weight of the liquid crystal composition 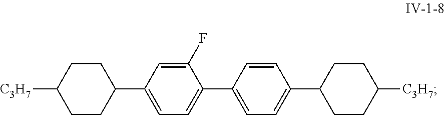
2% of the compound IV-1-5 based on the total weight of the liquid crystal composition 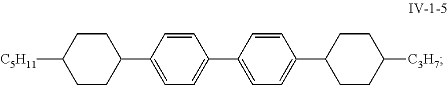
11% of the compound V-4 based on the total weight of the liquid crystal composition 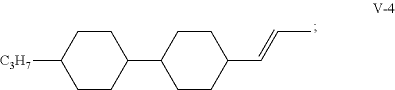
19.5% of the compound V-1 based on the total weight of the liquid crystal composition 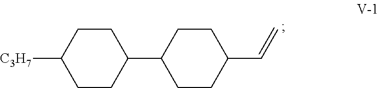
4% of the compound VII-2-3 based on the total weight of the liquid crystal composition 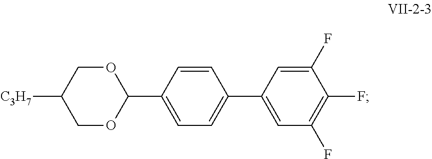
5% of the compound VII-2-4 based on the total weight of the liquid crystal composition 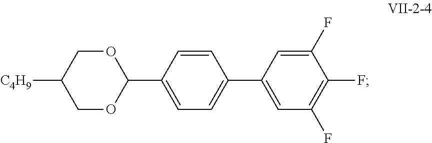
9% of the compound VII-1-3 based on the total weight of the liquid crystal composition 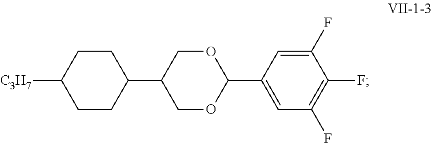
and
9% of the compound VII-1-5 based on the total weight of the liquid crystal composition 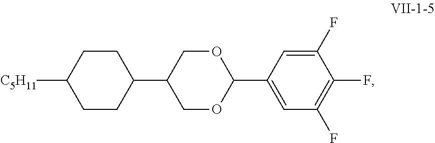
or the liquid crystal composition comprises:
9% of the compound II-3 based on the total weight of the liquid crystal composition 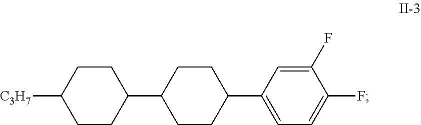
8% of the compound II-4 based on the total weight of the liquid crystal composition 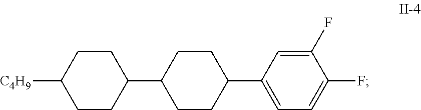
5% of the compound II-5 based on the total weight of the liquid crystal composition 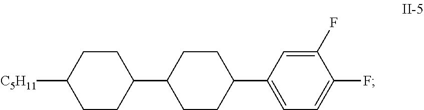
3% of the compound II-2 based on the total weight of the liquid crystal composition 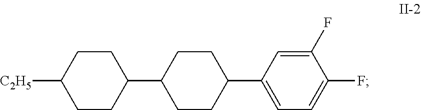 [SMILES: CCC1CCC(C2CCC(c3ccc(F)c(F)c3)CC2)CC1]
6% of the compound III-2 based on the total weight of the liquid crystal composition 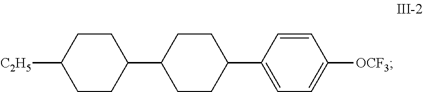 [SMILES: CCC1CCC(C2CCC(c3ccc(OC(F)(F)F)cc3)CC2)CC1]
9% of the compound III-3 based on the total weight of the liquid crystal composition 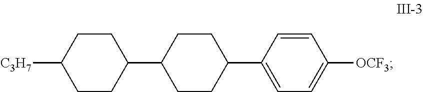
4% of the compound III-4 based on the total weight of the liquid crystal composition 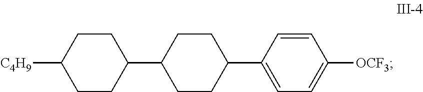
6% of the compound III-5 based on the total weight of the liquid crystal composition 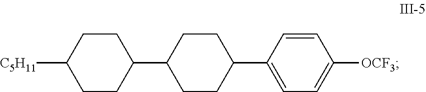
5.5% of the compound I-3 based on the total weight of the liquid crystal composition 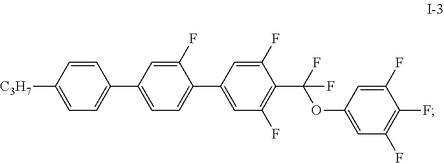
7% of the compound I-4 based on the total weight of the liquid crystal composition 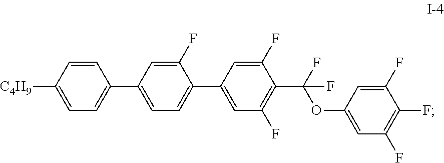
5.5% of the compound I-5 based on the total weight of the liquid crystal composition 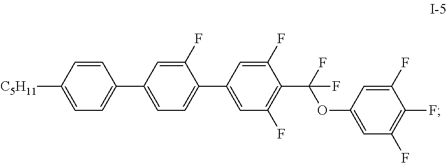
3.5% of the compound I-2 based on the total weight of the liquid crystal composition 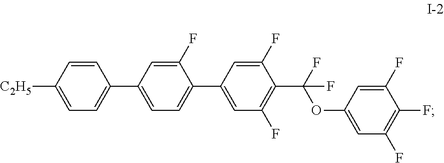 [SMILES: CCc1ccc(-c2ccc(-c3cc(F)c(C(F)(F)Oc4cc(F)c(F)c(F)c4)c(F)c3)c(F)c2)cc1]
1.5% of the compound IV-1-3 based on the total weight of the liquid crystal composition 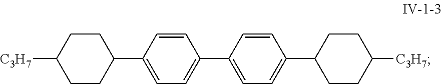
2% of the compound IV-1-5 based on the total weight of the liquid crystal composition 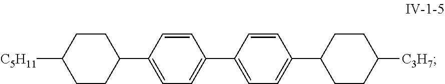
3.5% of the compound IV-2-3 based on the total weight of the liquid crystal composition 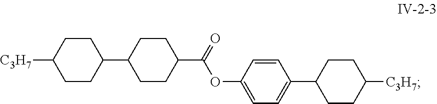
1.5% of the compound IV-2-5 based on the total weight of the liquid crystal composition 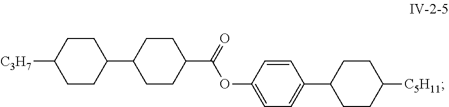
5% of the compound V-2 based on the total weight of the liquid crystal composition 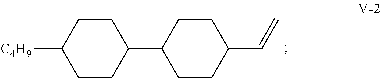
5% of the compound V-3 based on the total weight of the liquid crystal composition 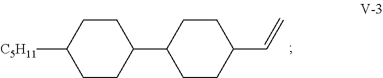
and
10% of the compound V-1 based on the total weight of the liquid crystal composition 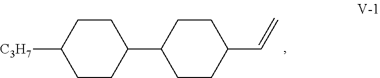
or the liquid crystal composition comprises:
6% of the compound II-3 based on the total weight of the liquid crystal composition 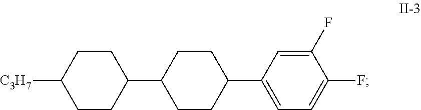
6% of the compound II-4 based on the total weight of the liquid crystal composition 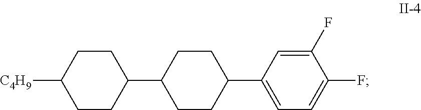
5% of the compound II-5 based on the total weight of the liquid crystal composition 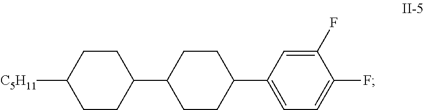
4% of the compound II-2 based on the total weight of the liquid crystal composition 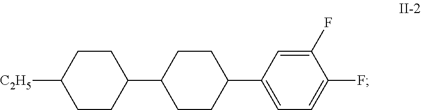 [SMILES: CCC1CCC(C2CCC(c3ccc(F)c(F)c3)CC2)CC1]
5% of the compound III-2 based on the total weight of the liquid crystal composition 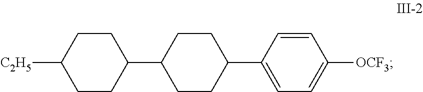 [SMILES: CCC1CCC(C2CCC(c3ccc(OC(F)(F)F)cc3)CC2)CC1]
3% of the compound III-3 based on the total weight of the liquid crystal composition 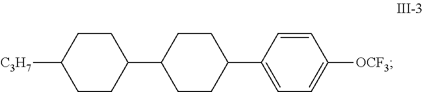
5% of the compound III-4 based on the total weight of the liquid crystal composition 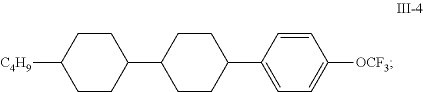
4% of the compound III-5 based on the total weight of the liquid crystal composition 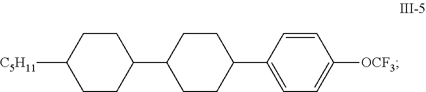
5% of the compound I-3 based on the total weight of the liquid crystal composition 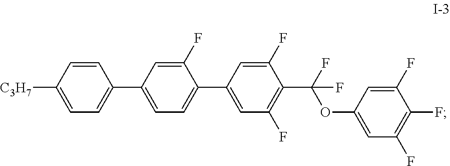
6% of the compound I-4 based on the total weight of the liquid crystal composition 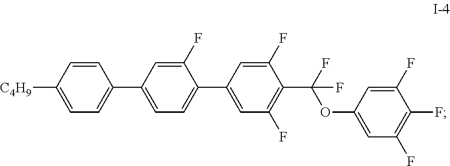
6% of the compound I-5 based on the total weight of the liquid crystal composition 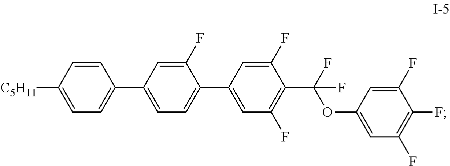
1.5% of the compound IV-1-3 based on the total weight of the liquid crystal composition 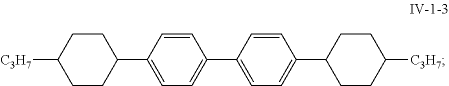
2% of the compound IV-1-8 based on the total weight of the liquid crystal composition 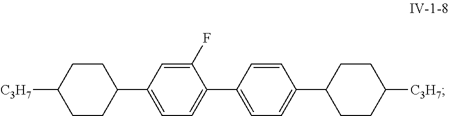
2% of the compound IV-1-5 based on the total weight of the liquid crystal composition 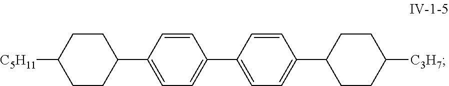
11% of the compound V-4 based on the total weight of the liquid crystal composition 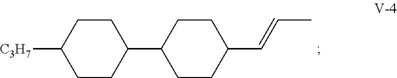
25.5% of the compound V-1 based on the total weight of the liquid crystal composition 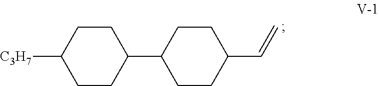
and
3% of the compound VII-1-3 based on the total weight of the liquid crystal composition

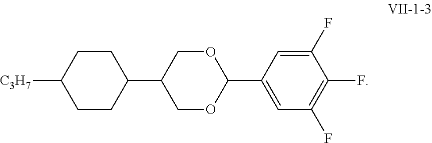

13. (canceled)

14. A liquid crystal display element, comprising the liquid crystal composition of claim 1.

15. The liquid crystal composition according to claim 2, wherein the liquid crystal composition comprises:
8% of the compound II-3 based on the total weight of the liquid crystal composition 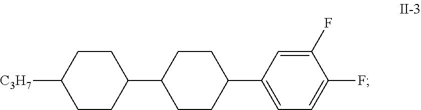
7% of the compound II-4 based on the total weight of the liquid crystal composition 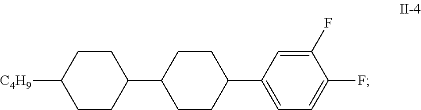
5% of the compound II-5 based on the total weight of the liquid crystal composition 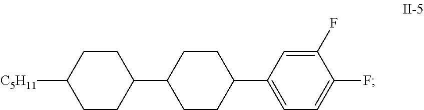
1% of the compound II-2 based on the total weight of the liquid crystal composition 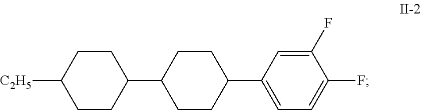 [SMILES: CCC1CCC(C2CCC(c3ccc(F)c(F)c3)CC2)CC1]
6% of the compound III-2 based on the total weight of the liquid crystal composition 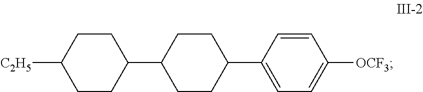 [SMILES: CCC1CCC(C2CCC(c3ccc(OC(F)(F)F)cc3)CC2)CC1]
9% of the compound III-3 based on the total weight of the liquid crystal composition 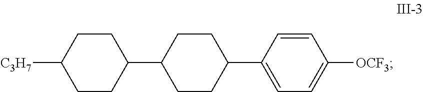
4% of the compound III-4 based on the total weight of the liquid crystal composition 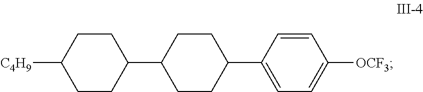
6.5% of the compound I-3 based on the total weight of the liquid crystal composition 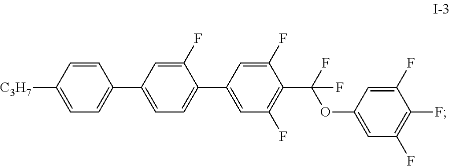
7% of the compound I-4 based on the total weight of the liquid crystal composition 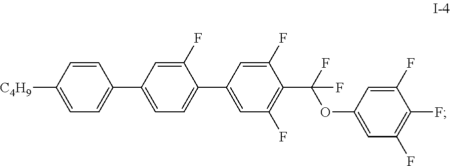
7% of the compound I-5 based on the total weight of the liquid crystal composition 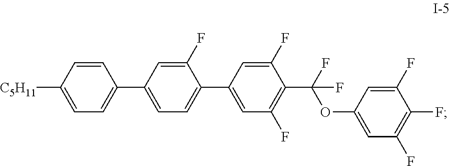
4% of the compound I-2 based on the total weight of the liquid crystal composition 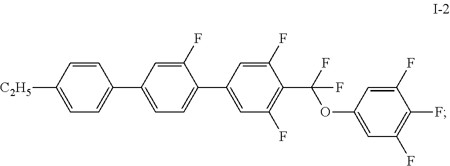 [SMILES: CCc1ccc(-c2ccc(-c3cc(F)c(C(F)(F)Oc4cc(F)c(F)c(F)c4)c(F)c3)c(F)c2)cc1]
1.5% of the compound IV-1-3 based on the total weight of the liquid crystal composition 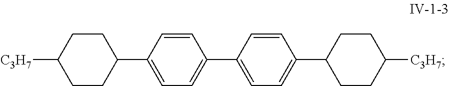
2% of the compound IV-1-8 based on the total weight of the liquid crystal composition 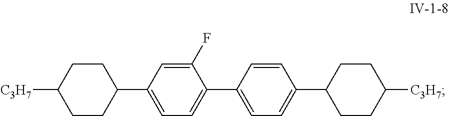
9% of the compound V-4 based on the total weight of the liquid crystal composition 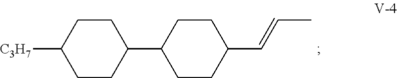
and
23% of the compound V-1 based on the total weight of the liquid crystal composition 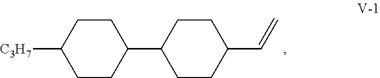
or the liquid crystal composition comprises:
9% of the compound II-3 based on the total weight of the liquid crystal composition 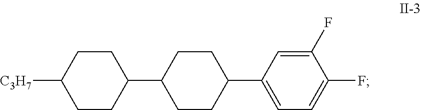
8% of the compound II-4 based on the total weight of the liquid crystal composition 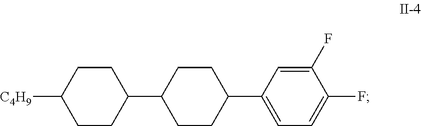
5% of the compound II-5 based on the total weight of the liquid crystal composition 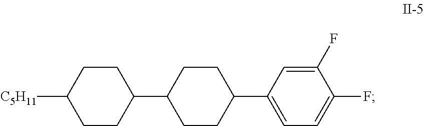
3% of the compound II-2 based on the total weight of the liquid crystal composition 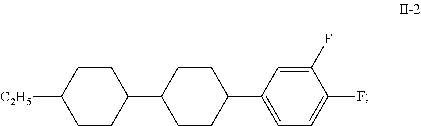 [SMILES: CCC1CCC(C2CCC(c3ccc(F)c(F)c3)CC2)CC1]
6% of the compound III-2 based on the total weight of the liquid crystal composition 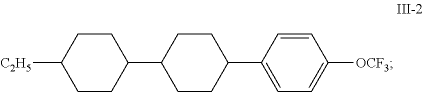 [SMILES: CCC1CCC(C2CCC(c3ccc(OC(F)(F)F)cc3)CC2)CC1]
9% of the compound III-3 based on the total weight of the liquid crystal composition 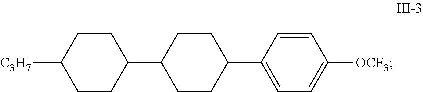
4% of the compound III-4 based on the total weight of the liquid crystal composition 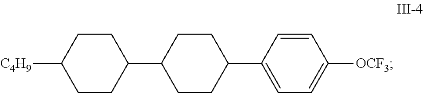
6% of the compound I-3 based on the total weight of the liquid crystal composition 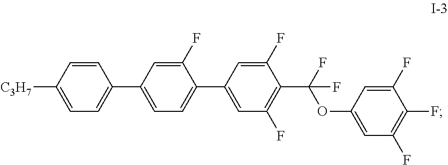
7% of the compound I-4 based on the total weight of the liquid crystal composition 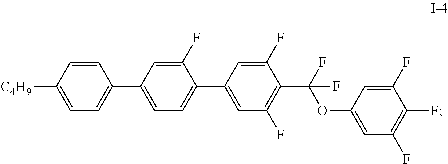
6% of the compound I-5 based on the total weight of the liquid crystal composition 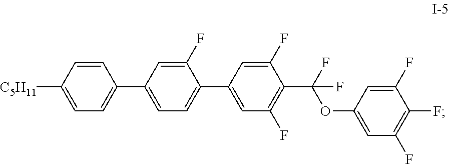
4% of the compound I-2 based on the total weight of the liquid crystal composition 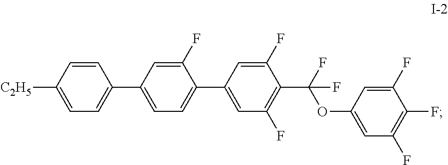 [SMILES: CCc1ccc(-c2ccc(-c3cc(F)c(C(F)(F)Oc4cc(F)c(F)c(F)c4)c(F)c3)c(F)c2)cc1]
1.5% of the compound IV-1-3 based on the total weight of the liquid crystal composition 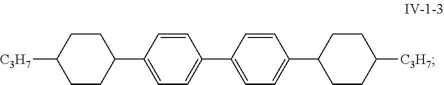
2% of the compound IV-1-5 based on the total weight of the liquid crystal composition 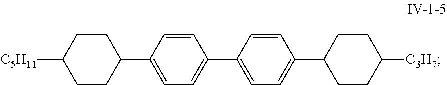
3.5% of the compound IV-2-3 based on the total weight of the liquid crystal composition 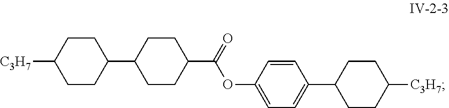
5% of the compound V-4 based on the total weight of the liquid crystal composition 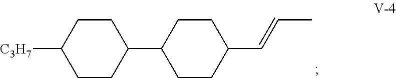
16% of the compound V-1 based on the total weight of the liquid crystal composition 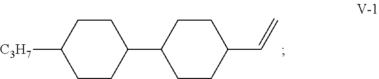
and
5% of the compound VI-7 based on the total weight of the liquid crystal composition 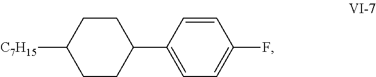
or the liquid crystal composition comprises:
4% of the compound II-3 based on the total weight of the liquid crystal composition 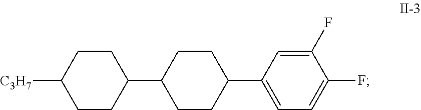
4% of the compound II-4 based on the total weight of the liquid crystal composition 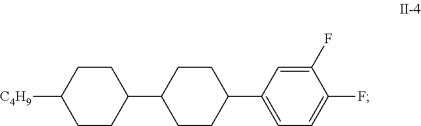
3% of the compound II-5 based on the total weight of the liquid crystal composition 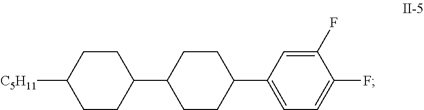
2% of the compound II-2 based on the total weight of the liquid crystal composition 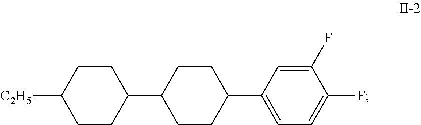 [SMILES: CCC1CCC(C2CCC(c3ccc(F)c(F)c3)CC2)CC1]
5% of the compound III-2 based on the total weight of the liquid crystal composition 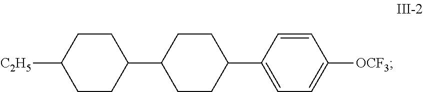 [SMILES: CCC1CCC(C2CCC(c3ccc(OC(F)(F)F)cc3)CC2)CC1]
3% of the compound III-3 based on the total weight of the liquid crystal composition 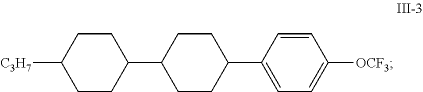
5% of the compound III-4 based on the total weight of the liquid crystal composition 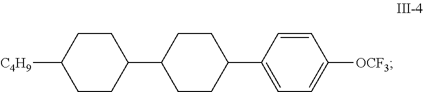
4% of the compound I-3 based on the total weight of the liquid crystal composition 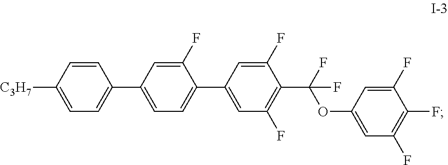
3% of the compound I-4 based on the total weight of the liquid crystal composition 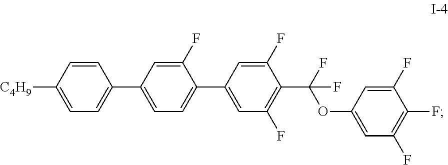
4% of the compound I-5 based on the total weight of the liquid crystal composition 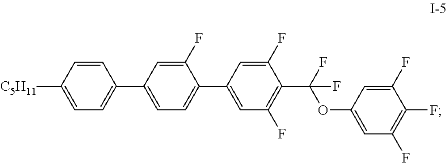
1.5% of the compound IV-1-3 based on the total weight of the liquid crystal composition 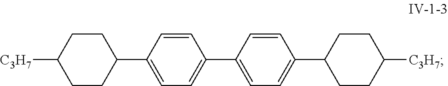
2% of the compound IV-1-8 based on the total weight of the liquid crystal composition 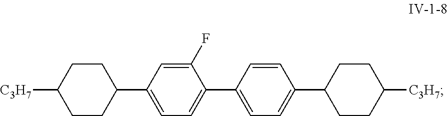
2% of the compound IV-1-5 based on the total weight of the liquid crystal composition 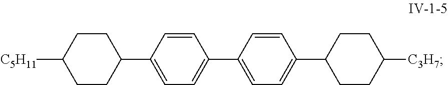
11% of the compound V-4 based on the total weight of the liquid crystal composition 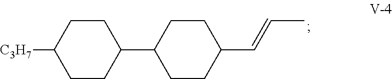
19.5% of the compound V-1 based on the total weight of the liquid crystal composition 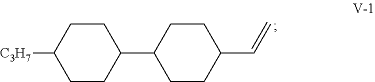
4% of the compound VII-2-3 based on the total weight of the liquid crystal composition 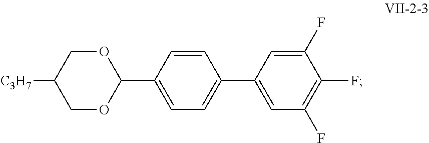
5% of the compound VII-2-4 based on the total weight of the liquid crystal composition 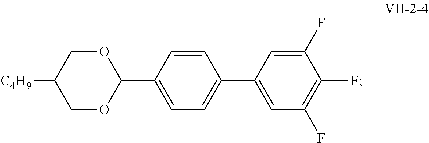
9% of the compound VII-1-3 based on the total weight of the liquid crystal composition 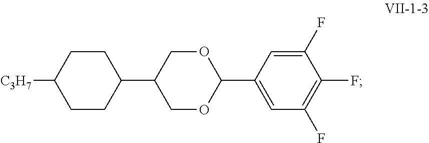
and
9% of the compound VII-1-5 based on the total weight of the liquid crystal composition 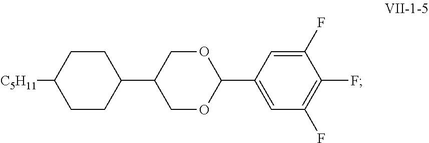
or the liquid crystal composition comprises:
9% of the compound II-3 based on the total weight of the liquid crystal composition 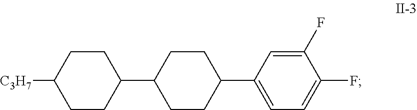
8% of the compound II-4 based on the total weight of the liquid crystal composition 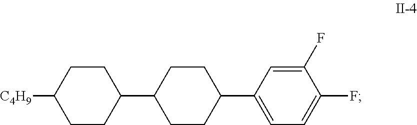
5% of the compound II-5 based on the total weight of the liquid crystal composition 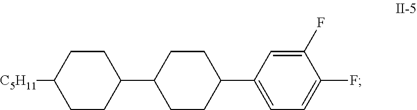
3% of the compound II-2 based on the total weight of the liquid crystal composition 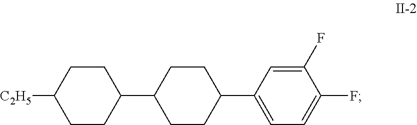 [SMILES: CCC1CCC(C2CCC(c3ccc(F)c(F)c3)CC2)CC1]
6% of the compound III-2 based on the total weight of the liquid crystal composition 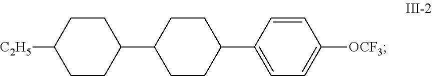 [SMILES: CCC1CCC(C2CCC(c3ccc(OC(F)(F)F)cc3)CC2)CC1]
9% of the compound III-3 based on the total weight of the liquid crystal composition 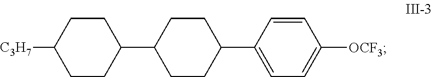
4% of the compound III-4 based on the total weight of the liquid crystal composition 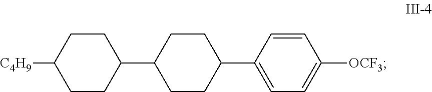
6% of the compound III-5 based on the total weight of the liquid crystal composition 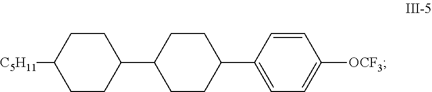
5.5% of the compound I-3 based on the total weight of the liquid crystal composition 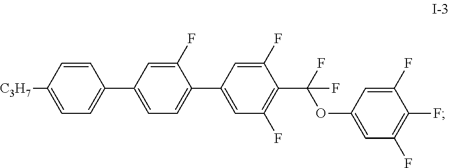
7% of the compound I-4 based on the total weight of the liquid crystal composition 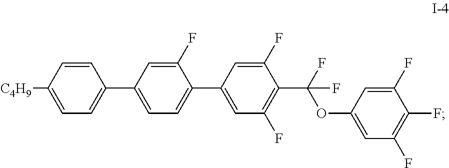
5.5% of the compound I-5 based on the total weight of the liquid crystal composition 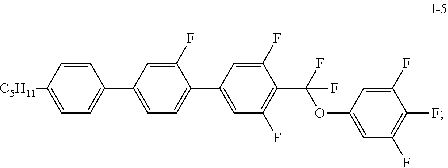
3.5% of the compound I-2 based on the total weight of the liquid crystal composition 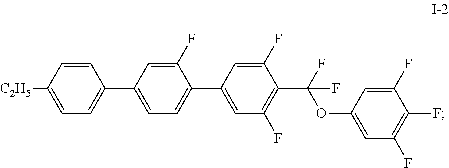 [SMILES: CCc1ccc(-c2ccc(-c3cc(F)c(C(F)(F)Oc4cc(F)c(F)c(F)c4)c(F)c3)c(F)c2)cc1]
1.5% of the compound IV-1-3 based on the total weight of the liquid crystal composition 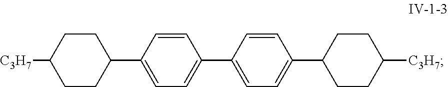
2% of the compound IV-1-5 based on the total weight of the liquid crystal composition 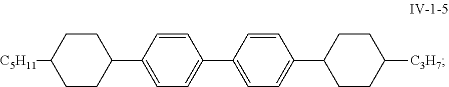
3.5% of the compound IV-2-3 based on the total weight of the liquid crystal composition 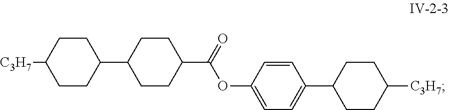
1.5% of the compound IV-2-5 based on the total weight of the liquid crystal composition 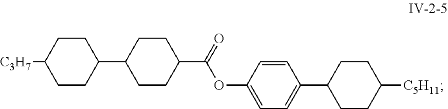
5% of the compound V-2 based on the total weight of the liquid crystal composition 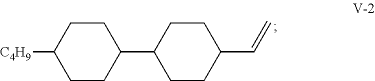
5% of the compound V-3 based on the total weight of the liquid crystal composition 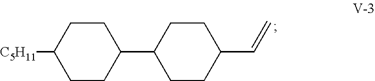
and
10% of the compound V-1 based on the total weight of the liquid crystal composition 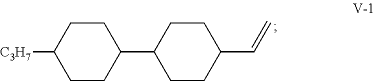
or the liquid crystal composition comprises:
6% of the compound II-3 based on the total weight of the liquid crystal composition 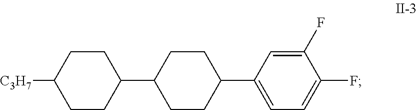
6% of the compound II-4 based on the total weight of the liquid crystal composition 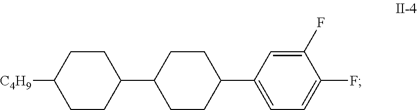
5% of the compound II-5 based on the total weight of the liquid crystal composition 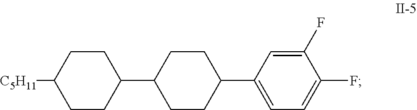
4% of the compound II-2 based on the total weight of the liquid crystal composition 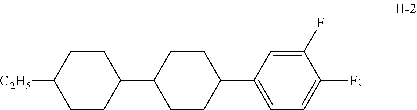 [SMILES: CCC1CCC(C2CCC(c3ccc(F)c(F)c3)CC2)CC1]
5% of the compound III-2 based on the total weight of the liquid crystal composition 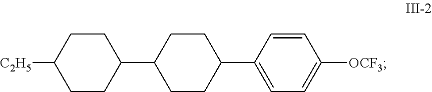 [SMILES: CCC1CCC(C2CCC(c3ccc(OC(F)(F)F)cc3)CC2)CC1]
3% of the compound III-3 based on the total weight of the liquid crystal composition 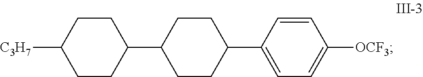
5% of the compound III-4 based on the total weight of the liquid crystal composition 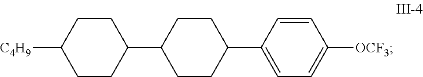
4% of the compound III-5 based on the total weight of the liquid crystal composition 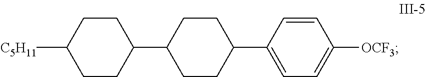
5% of the compound I-3 based on the total weight of the liquid crystal composition 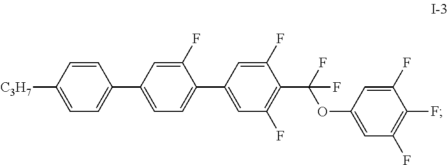
6% of the compound I-4 based on the total weight of the liquid crystal composition 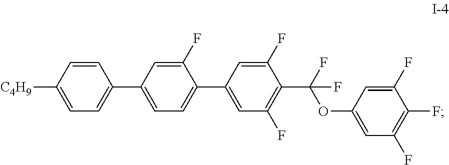
6% of the compound I-5 based on the total weight of the liquid crystal composition 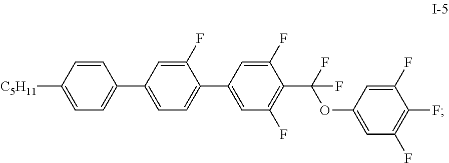
1.5% of the compound IV-1-3 based on the total weight of the liquid crystal composition 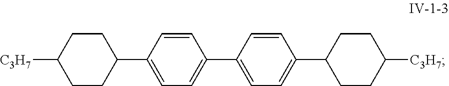
2% of the compound IV-1-8 based on the total weight of the liquid crystal composition 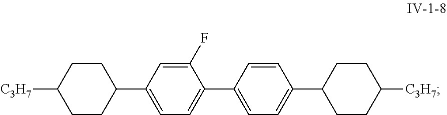
2% of the compound IV-1-5 based on the total weight of the liquid crystal composition 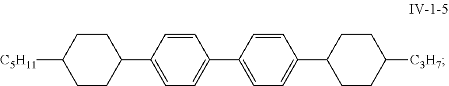
11% of the compound V-4 based on the total weight of the liquid crystal composition 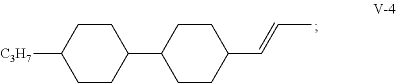
25.5% of the compound V-1 based on the total weight of the liquid crystal composition 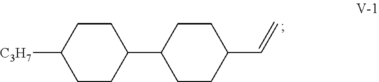
and
3% of the compound VII-1-3 based on the total weight of the liquid crystal composition

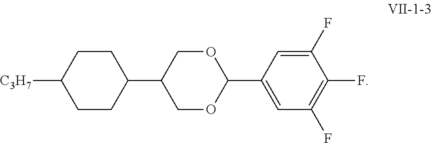

16. The liquid crystal composition according to claim 3, wherein the liquid crystal composition comprises:
8% of the compound II-3 based on the total weight of the liquid crystal composition 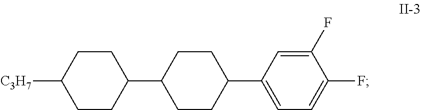
7% of the compound II-4 based on the total weight of the liquid crystal composition 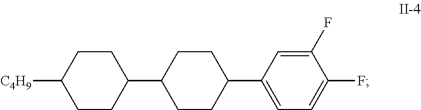
5% of the compound II-5 based on the total weight of the liquid crystal composition 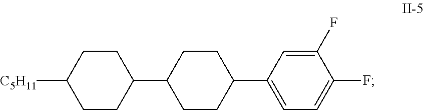
1% of the compound II-2 based on the total weight of the liquid crystal composition 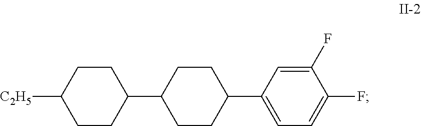 [SMILES: CCC1CCC(C2CCC(c3ccc(F)c(F)c3)CC2)CC1]
6% of the compound III-2 based on the total weight of the liquid crystal composition 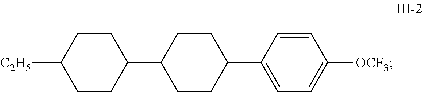 [SMILES: CCC1CCC(C2CCC(c3ccc(OC(F)(F)F)cc3)CC2)CC1]
9% of the compound III-3 based on the total weight of the liquid crystal composition 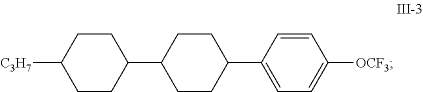
4% of the compound III-4 based on the total weight of the liquid crystal composition 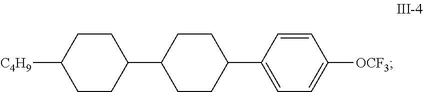
6.5% of the compound I-3 based on the total weight of the liquid crystal composition 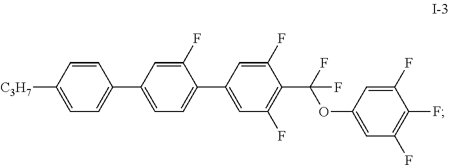
7% of the compound I-4 based on the total weight of the liquid crystal composition 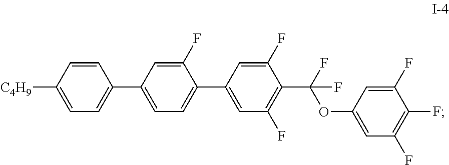
7% of the compound I-5 based on the total weight of the liquid crystal composition 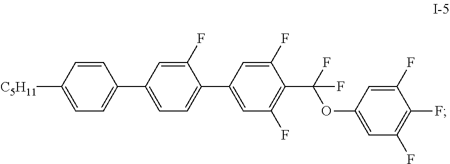
4% of the compound I-2 based on the total weight of the liquid crystal composition 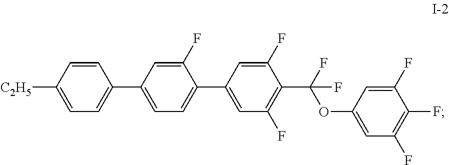 [SMILES: CCc1ccc(-c2ccc(-c3cc(F)c(C(F)(F)Oc4cc(F)c(F)c(F)c4)c(F)c3)c(F)c2)cc1]
1.5% of the compound IV-1-3 based on the total weight of the liquid crystal composition 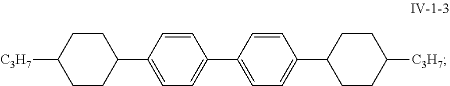
2% of the compound IV-1-8 based on the total weight of the liquid crystal composition 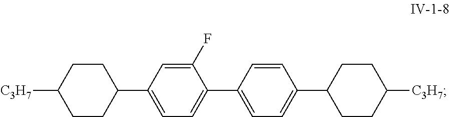
9% of the compound V-4 based on the total weight of the liquid crystal composition 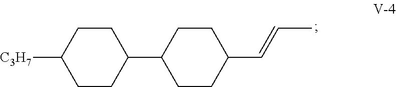
and
23% of the compound V-1 based on the total weight of the liquid crystal composition 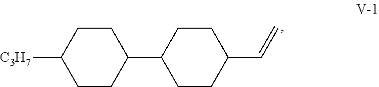
or the liquid crystal composition comprises:
9% of the compound II-3 based on the total weight of the liquid crystal composition 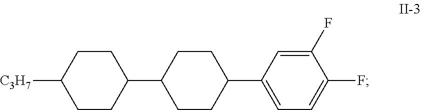
8% of the compound II-4 based on the total weight of the liquid crystal composition 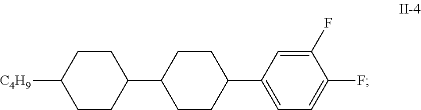
5% of the compound II-5 based on the total weight of the liquid crystal composition 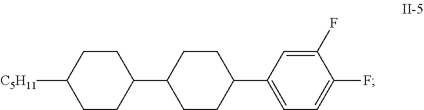
3% of the compound II-2 based on the total weight of the liquid crystal composition 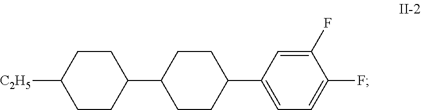 [SMILES: CCC1CCC(C2CCC(c3ccc(F)c(F)c3)CC2)CC1]
6% of the compound III-2 based on the total weight of the liquid crystal composition 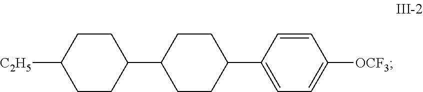 [SMILES: CCC1CCC(C2CCC(c3ccc(OC(F)(F)F)cc3)CC2)CC1]
9% of the compound III-3 based on the total weight of the liquid crystal composition 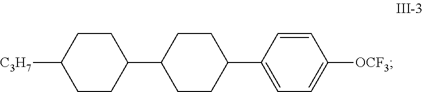
4% of the compound III-4 based on the total weight of the liquid crystal composition 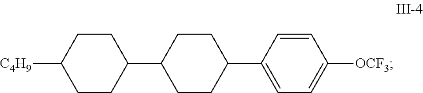
6% of the compound I-3 based on the total weight of the liquid crystal composition 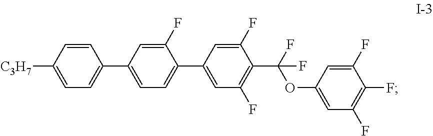
7% of the compound I-4 based on the total weight of the liquid crystal composition 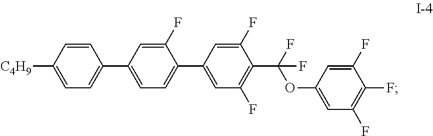
6% of the compound I-5 based on the total weight of the liquid crystal composition 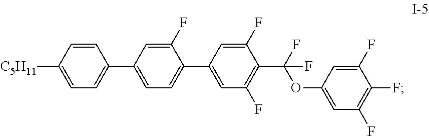
4% of the compound I-2 based on the total weight of the liquid crystal composition 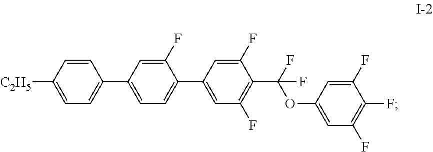 [SMILES: CCc1ccc(-c2ccc(-c3cc(F)c(C(F)(F)Oc4cc(F)c(F)c(F)c4)c(F)c3)c(F)c2)cc1]
1.5% of the compound IV-1-3 based on the total weight of the liquid crystal composition 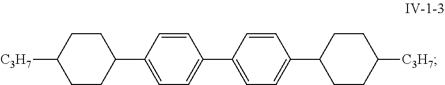
2% of the compound IV-1-5 based on the total weight of the liquid crystal composition 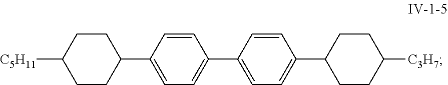
3.5% of the compound IV-2-3 based on the total weight of the liquid crystal composition 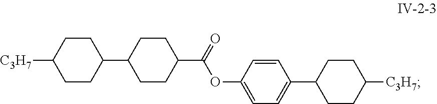
5% of the compound V-4 based on the total weight of the liquid crystal composition 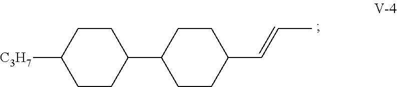
16% of the compound V-1 based on the total weight of the liquid crystal composition 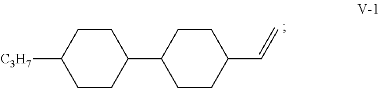
and
5% of the compound VI-7 based on the total weight of the liquid crystal composition 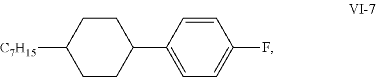
or the liquid crystal composition comprises:
4% of the compound II-3 based on the total weight of the liquid crystal composition 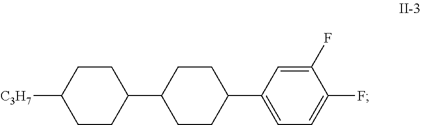
4% of the compound II-4 based on the total weight of the liquid crystal composition 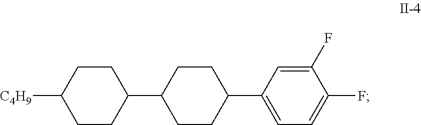
3% of the compound II-5 based on the total weight of the liquid crystal composition 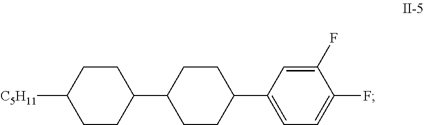
2% of the compound II-2 based on the total weight of the liquid crystal composition 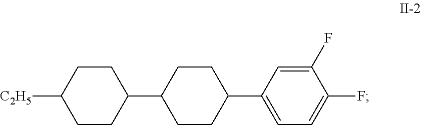 [SMILES: CCC1CCC(C2CCC(c3ccc(F)c(F)c3)CC2)CC1]
5% of the compound III-2 based on the total weight of the liquid crystal composition 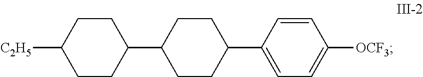 [SMILES: CCC1CCC(C2CCC(c3ccc(OC(F)(F)F)cc3)CC2)CC1]
3% of the compound III-3 based on the total weight of the liquid crystal composition 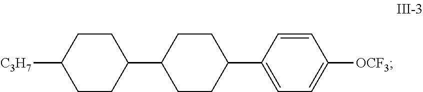
5% of the compound III-4 based on the total weight of the liquid crystal composition 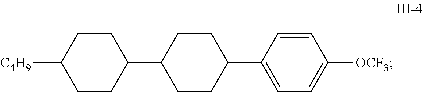
4% of the compound I-3 based on the total weight of the liquid crystal composition 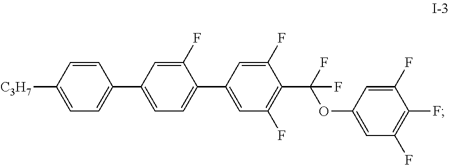
3% of the compound I-4 based on the total weight of the liquid crystal composition 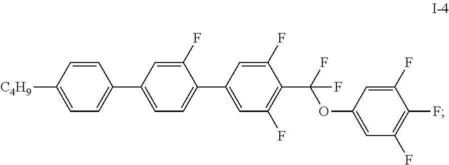
4% of the compound I-5 based on the total weight of the liquid crystal composition 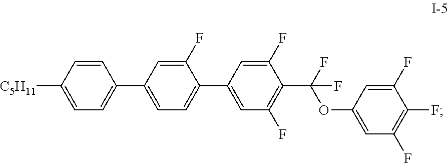
1.5% of the compound IV-1-3 based on the total weight of the liquid crystal composition 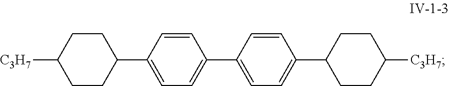
2% of the compound IV-1-8 based on the total weight of the liquid crystal composition 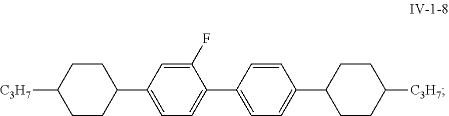
2% of the compound IV-1-5 based on the total weight of the liquid crystal composition 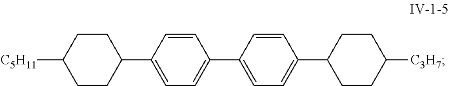
11% of the compound V-4 based on the total weight of the liquid crystal composition 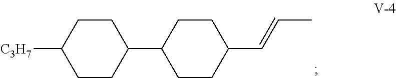
19.5% of the compound V-1 based on the total weight of the liquid crystal composition 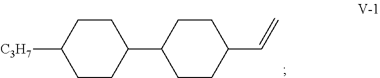
4% of the compound VII-2-3 based on the total weight of the liquid crystal composition 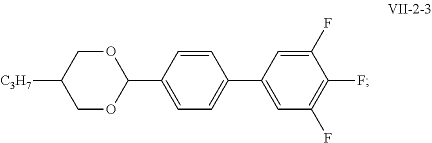
5% of the compound VII-2-4 based on the total weight of the liquid crystal composition 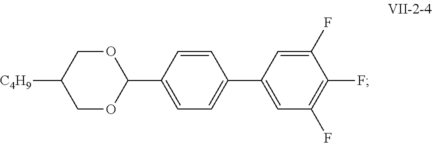
9% of the compound VII-1-3 based on the total weight of the liquid crystal composition 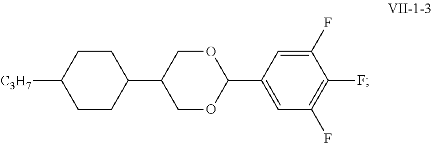
and
9% of the compound VII-1-5 based on the total weight of the liquid crystal composition 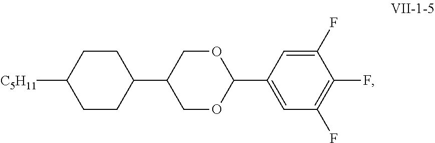
or the liquid crystal composition comprises:
9% of the compound II-3 based on the total weight of the liquid crystal composition 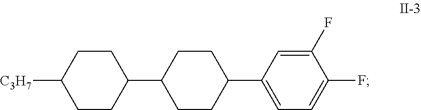
8% of the compound II-4 based on the total weight of the liquid crystal composition 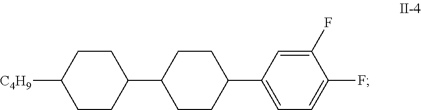
5% of the compound II-5 based on the total weight of the liquid crystal composition 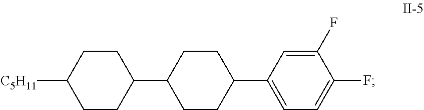
3% of the compound II-2 based on the total weight of the liquid crystal composition 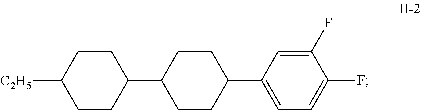 [SMILES: CCC1CCC(C2CCC(c3ccc(F)c(F)c3)CC2)CC1]
6% of the compound III-2 based on the total weight of the liquid crystal composition 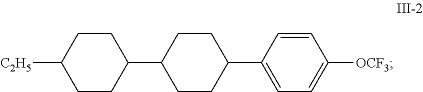 [SMILES: CCC1CCC(C2CCC(c3ccc(OC(F)(F)F)cc3)CC2)CC1]
9% of the compound III-3 based on the total weight of the liquid crystal composition 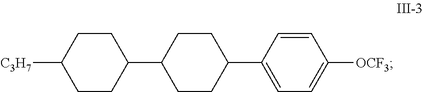
4% of the compound III-4 based on the total weight of the liquid crystal composition 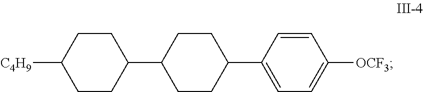
6% of the compound III-5 based on the total weight of the liquid crystal composition 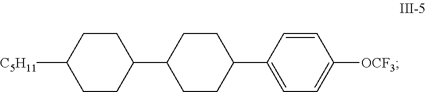
5.5% of the compound I-3 based on the total weight of the liquid crystal composition 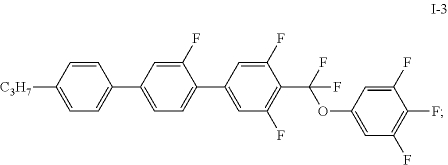
7% of the compound I-4 based on the total weight of the liquid crystal composition 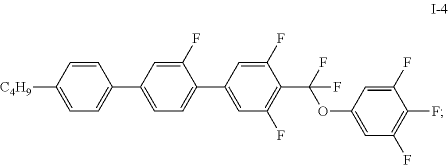
5.5% of the compound I-5 based on the total weight of the liquid crystal composition 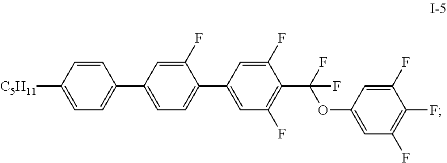
3.5% of the compound I-2 based on the total weight of the liquid crystal composition 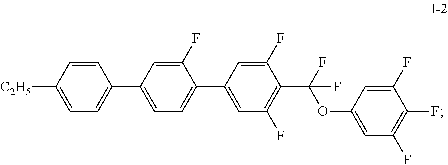 [SMILES: CCc1ccc(-c2ccc(-c3cc(F)c(C(F)(F)Oc4cc(F)c(F)c(F)c4)c(F)c3)c(F)c2)cc1]
1.5% of the compound IV-1-3 based on the total weight of the liquid crystal composition 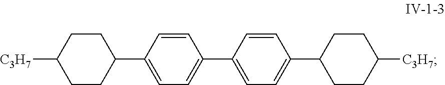
2% of the compound IV-1-5 based on the total weight of the liquid crystal composition 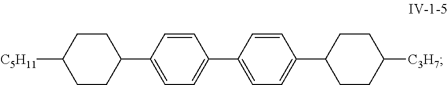
3.5% of the compound IV-2-3 based on the total weight of the liquid crystal composition 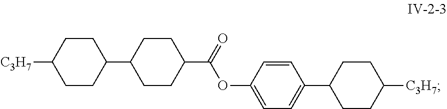
1.5% of the compound IV-2-5 based on the total weight of the liquid crystal composition 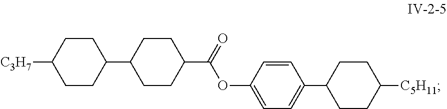
5% of the compound V-2 based on the total weight of the liquid crystal composition 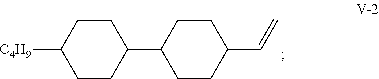
5% of the compound V-3 based on the total weight of the liquid crystal composition 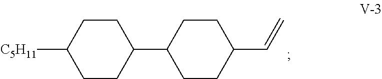
and
10% of the compound V-1 based on the total weight of the liquid crystal composition 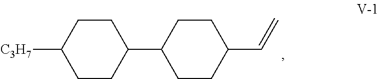
or the liquid crystal composition comprises:
6% of the compound II-3 based on the total weight of the liquid crystal composition 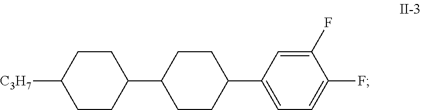
6% of the compound II-4 based on the total weight of the liquid crystal composition 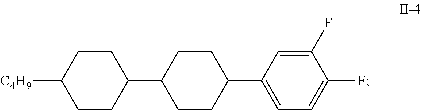
5% of the compound II-5 based on the total weight of the liquid crystal composition 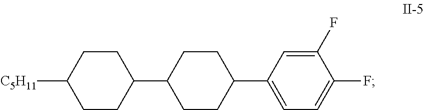
4% of the compound II-2 based on the total weight of the liquid crystal composition 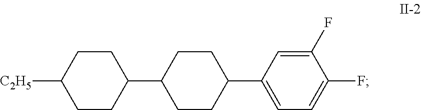 [SMILES: CCC1CCC(C2CCC(c3ccc(F)c(F)c3)CC2)CC1]
5% of the compound III-2 based on the total weight of the liquid crystal composition 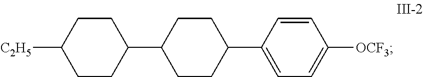 [SMILES: CCC1CCC(C2CCC(c3ccc(OC(F)(F)F)cc3)CC2)CC1]
3% of the compound III-3 based on the total weight of the liquid crystal composition 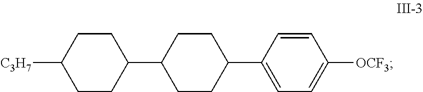
5% of the compound III-4 based on the total weight of the liquid crystal composition 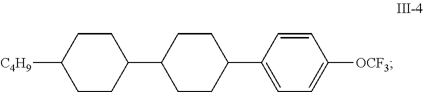
4% of the compound III-5 based on the total weight of the liquid crystal composition 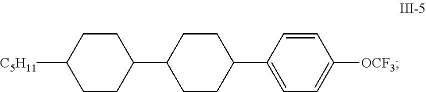
5% of the compound I-3 based on the total weight of the liquid crystal composition 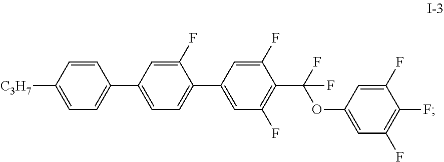
6% of the compound I-4 based on the total weight of the liquid crystal composition 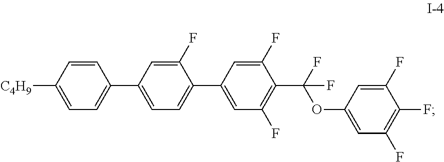
6% of the compound I-5 based on the total weight of the liquid crystal composition 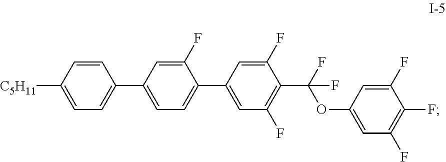
1.5% of the compound IV-1-3 based on the total weight of the liquid crystal composition 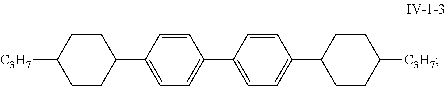
2% of the compound IV-1-8 based on the total weight of the liquid crystal composition 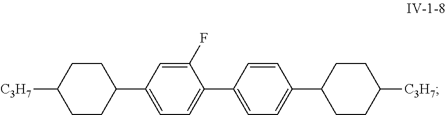
2% of the compound IV-1-5 based on the total weight of the liquid crystal composition 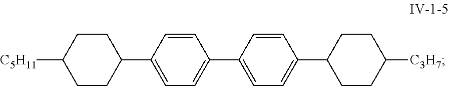
11% of the compound V-4 based on the total weight of the liquid crystal composition 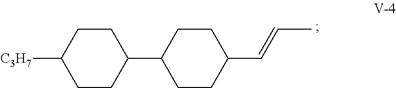
25.5% of the compound V-1 based on the total weight of the liquid crystal composition 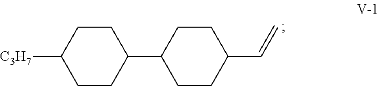
and
3% of the compound VII-1-3 based on the total weight of the liquid crystal composition

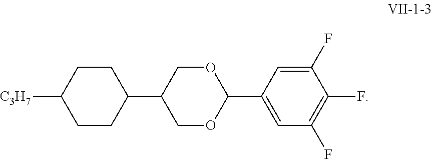

17. A liquid crystal display element, comprising the liquid crystal composition of claim 2.

18. A liquid crystal display element, comprising the liquid crystal composition of claim 3.

19. A liquid crystal display element, comprising the liquid crystal composition of claim 12.

20. (canceled)
